(19) United States
(12) Patent Application Publication
(10) Pub. No.: US 2015/0100342 A1
(43) Pub. Date: Apr. 9, 2015

(54) MOBILE APP FOR CONTACT LENSES

(71) Applicant: Mobile Doctor Investments, LLC, Urbandale, IA (US)

(72) Inventor: Justin Schulte, Urbandale, IA (US)

(21) Appl. No.: 14/508,048

(22) Filed: Oct. 7, 2014

Related U.S. Application Data
(60) Provisional application No. 61/888,052, filed on Oct. 8, 2013.

(51) Int. Cl. G06F 19/00; G06Q 10/08; G06Q 30/06

(52) U.S. Cl. CPC G06F 19/3456; G06Q 30/0633; G06Q 10/083
USPC 705/2

(57) ABSTRACT

A method includes providing a mobile application for use on a mobile device. The mobile application includes a first portion for use by an eye care provider and a second portion for use by a contact lens user. The first portion provides a user interface to the eye care provider for specifying contact lens parameters for the contact lenses and for generating a code associated with the contact lens user. The second portion provides a user interface to the contact lens user for inputting the code to register and then for managing contact lens ordering.

### CROSS REFERENCE TO RELATED APPLICATION

This application claims the benefit of U.S. Provisional Application No. 61/888,052 filed Oct. 8, 2013.

### FIELD OF THE INVENTION

This invention relates to contact lenses. More particularly, but without limitation, the invention relates to methods and systems for ordering contact lenses using a mobile application.

### BACKGROUND OF THE INVENTION

Since the development of contact lenses, patients have been visiting eye care providers to receive prescriptions for contact lenses. After a contact lens fitting by the eye care provider, historically the eye care provider secured the contact lenses for the patient. This process is convenient for the patient because of the established and trusted relationship between the patient and their eye care provider. It is also convenient because the patient is present at the eye care provider's office at the time of the examination. This process is also beneficial for the eye care provider because it provides an additional stream of revenue as the eye care provider has the ability to mark-up the price of the contact lenses.

However, this process also has its drawbacks. Namely, the eye care provider is required to maintain substantial additional overhead to manage the facilitation process. In some cases, this includes carrying inventory, and in other cases this requires maintaining staff that receives and processes the orders for contact lenses and interfaces with the patients regarding their orders. Another drawback to this process is related to the fact that the process of ordering contact lenses historically has been a labor intensive and time consuming process because orders are manually entered and the process requires phone calls, faxes and other time-consuming and antiquated procedures. To further complicate matters, due to the manual nature of this process, mistakes or clerical errors are often made leading to further costs, delays and labor to correct. Another drawback to ordering contact lenses from the eye care provider is, due in-part to these overhead costs, conventional eye care providers may not be able to compete with discount pricing from online retailers and big box stores.

Over time, various alternatives to ordering contact lenses directly through the patient's eye care provider were developed to at least partially address or alleviate many of these drawbacks.

As one alternative, 1-800-CONTACTS was developed to provide a service where a patient calls in and reports their own contact prescription provided to them by their eye care provider. 1-800-CONTACTS provides the benefit to the patient of essentially cutting-out the middleman and puts the patient in direct contact with a discount supplier. Due to their volume, 1-800-CONTACTS is able to provide contacts to the patient at a lower average cost than an average eye care provider.

While, the 1-800-CONTACTS model, or similar models, has some benefits, it too has its drawbacks. That is, upon receiving an order from a patient, 1-800-CONTACTS must verify the patient's prescription. This verification is facilitated by a representative of 1-800-CONTACTS calling, faxing and/or e-mailing the eye care provider with a request to verify the prescription. The eye care provider then has to receive and review the request for verification, compare it to the eye care provider's record of the prescription and verify that it is correct or otherwise correct any errors therein. Then the eye care provider has to call, fax or e-mail 1-800-CONTACTS back with a verification or correction. This manual verification process is inherently time consuming, inefficient and labor intensive, and it is something that the eye-care provider is not monetarily compensated for in any way.

In the event the eye care provider does not respond to the request for verification after a predetermined amount of time, such as 48-hours, 1-800-CONTACTS presumes the prescription is correct (passively verified) and then fulfills the order. This means that the double-check of the manual verification process may or may not have occurred which raises the potential for an inaccurate order. In addition, this causes an unnecessary delay in fulfilling the order without any benefit whatsoever.

As such, the 1-800-CONTACTS model is undesirable for the eye care provider because not only does it siphon away potential revenue from the eye care provider by taking away potential contact lens orders, it also requires the eye care provider to allocate time and energy to verify prescriptions. Similarly, the 1-800-CONTACTS model is undesirable for a patient because it has the potential for increased delay due to the time required for the manual verification (or passive verification if the predetermined amount of time passes without manual verification) and it has an increased potential for inaccurate ordering due to the requirement for the patient to report their own prescription details as well as the potential that the prescription may not be verified. Furthermore, this process is inconvenient for the patient because the patient must take time out of their day to order their own contact lenses. In addition, it can be an uncomfortable and intimidating procedure because the patient is unfamiliar with the process of ordering contact lenses. Therefore, many drawbacks exist with this process.

As another alternative, various online services have been developed such as 1800contacts.com, visiondirect.com and the like. These online services provide a website wherein the patient enters their prescription details and their eye care provider's name. Then, as is described above, these services call, fax or e-mail a verification request to the eye care provider, which then must be addressed as is described above. Therefore, these online services suffer from the same deficiencies as is identified above.

As yet another alternative, various big-box stores such as Costco, Target and Walmart that have pharmacies therein began offering contact lens prescription fulfillment. While these big box stores due to their size and volume are able to provide some discount to the patient over the traditional process of purchasing contact lenses through their independent eye care provider, this process suffers from the same deficiencies as is identified above. That is, these big-box stores follow the same antiquated process as is identified above and therefore this process suffers from the same disadvantages as is described above.

Accordingly, what is needed is a better way to order contacts and eliminate issues with prescription verification that benefits both patients as well as eye care providers.

### SUMMARY OF THE INVENTION

Therefore, it is a primary object, feature, or advantage of the invention to provide a system for ordering contact lenses that improves upon the state of the art.

Another object, feature, or advantage of the invention is to provide a system for ordering contact lenses that provides for quick, easy and efficient active verification of a contact lens prescription.

Yet another object, feature, or advantage of the invention is to provide a system for ordering contact lenses that is easy for the patient to use.

Another object, feature, or advantage of the invention is to provide a system for ordering contact lenses that is easy for the eye care provider to use.

Yet another object, feature, or advantage of the invention is to provide a system for ordering contact lenses that reduces the cost to patients when ordering contact lenses.

Another object, feature, or advantage of the invention is to provide a system for ordering contact lenses that reduces the cost to eye care providers when ordering contact lenses.

Yet another object, feature, or advantage of the invention is to provide a system for ordering contact lenses that is efficient.

Another object, feature, or advantage of the invention is to provide a system for ordering contact lenses that eliminates the need to manually verify a contact lens prescription by an eye care provider.

Yet another object, feature, or advantage of the invention is to provide a system for ordering contact lenses that is simple.

Another object, feature, or advantage of the invention is to provide a system for ordering contact lenses that is straight forward.

Yet another object, feature, or advantage of the invention is to provide a system for ordering contact lenses that eliminates the need to manually enter prescription parameters or prescription information.

Another object, feature, or advantage of the invention is to provide a system for ordering contact lenses that allows the patient to scan in a code that automatically connects them to their prescription information.

Yet another object, feature, or advantage of the invention is to provide a system for ordering contact lenses that provides an incentive for patients to use, namely ease of use, efficiency of use, simplicity and low prices.

Another object, feature, or advantage of the invention is to provide a system for ordering contact lenses that provides an incentive for eye care providers to use, namely ease of use, efficiency of use, simplicity and low prices and eliminating the need for manual verification.

Yet another object, feature, or advantage of the invention is to provide a system for ordering contact lenses that improves the accuracy of ordering contact lenses.

Another object, feature, or advantage of the invention is to provide a system for ordering contact lenses that provides a financial benefit to the eye care provider for using the system.

Yet another object, feature, or advantage of the invention is to provide a system for ordering contact lenses that provides improve patient compliance with contact lens replacement schedules by providing reminders on mobile devices.

Another object, feature, or advantage of the invention to provide an annual examination recall reminder (such as at 11 months from their last contact lens prescription date) specific to a provider via local push notification on a mobile device.

Yet another object, feature, or advantage of the invention that participating providers have the capability to communicate with their patients via local push notification on their mobile devices.

Another object, feature, or advantage of the invention to improve office efficiency by eliminating contact lens prescription verification or ordering, and eliminating shipping costs, packaging, and phone calls regarding fulfillment of contact lens orders.

A still further object, feature, or advantage of the invention is to provide a doctor contact lens calculator such as for vertex distance and crossed cylinder.

Another object, feature, or advantage of the invention is to provide for manufacturer promotions.

Yet another object, feature, or advantage of the invention is to provide the convenience of multiple users and addresses associated with a single account as may be appropriate for use by a family.

Another object, feature, or advantage of the invention is to provide for profit sharing for care providers.

Another object, feature, or advantage is to provide for improved patient compliance.

One or more of these and/or other objects, features, or advantages of the invention will become apparent from the specification, drawings and claims that follow. No single embodiment need provide each or every object, feature, or advantage discussed herein. It is to be appreciated that different embodiments may have different objects, features, or advantages.

According to one aspect, a method includes providing a mobile application for use on a mobile device. The mobile application includes a first portion for use by an eye care provider and a second portion for use by a contact lens user. The first portion provides a user interface to the eye care provider for specifying contact lens parameters for the contact lenses and for generating a code associated with the contact lens user. The second portion provides a user interface to the contact lens user for inputting the code to register and then for managing contact lens ordering.

According to another aspect, a non-transitory computer readable storage medium for executing on a mobile device is provided which includes instructions for a mobile application. The mobile application includes a first portion for use by an eye care provider and a second portion for use by a contact lens user, wherein the first portion provides a user interface to the eye care provider for specifying contact lens parameters for the contact lenses and for generating a code associated with the contact lens user, and wherein the second portion provides a user interface to the contact lens user for inputting the code to register and then for managing contact lens ordering.

According to another aspect, a method of providing active contact lens verification is provided. The method includes electronically recording by an eye care provider contact lens parameters for a patient, electronically sending by the eye care provider the contact lens parameters to a cloud-based service, associating a code with the patient, providing the code to the patient, receiving the code from the patient through the cloud-based service to register the patient with the cloud-based service, and receiving an order for contact lens characterized by the contact lens parameters from the patient.

According to another aspect, a method includes providing a web-based application associated with a database, accessing the application by an eye care provider, establishing an eye care provider account in the application by an eye care provider, assigning a passcode to the eye care provider by the application, examining a patient by the eye care provider prescribing a prescription by the eye care provider to the patient and associating the prescription with the passcode assigned to the eye care provider in the application. The system also includes accessing the application by the patient, establishing a patient account in the application by the patient, entering the passcode by the patient, verifying the passcode entered by the patient with the passcode associated with the prescription, ordering the prescription by the patient through the application and shipping the prescription to the patient by a supplier.

According to another aspect of the invention, a method includes providing a web-based application having a database, accessing the application by an eye care provider over an electronic network through an electronic device having a display, establishing an eye care provider's account in the application by an eye care provider, examining a patient by the eye care provider, providing a prescription for the patient by the eye care provider, associating the prescription with a first passcode assigned to the eye care provider, providing a card having a code thereon, associating the code with the prescription in the application, and providing the card to the patient. The method also includes accessing the application by the patient over an electronic network through an electronic device having a display, establishing a patient account in the application by the patient, entering the code from the card into the application by the patient, verifying the code entered by the patient matches or corresponds with the code associated with the prescription by the application, displaying the prescription to the patient through the application on the patient's electronic device and ordering the prescription through the application by the patient.

According to another aspect, a method includes providing an application for use on an internet enabled device, associating the application with a database, providing a first portion in the application for use by an eye care provider, the first portion having a user interface for specifying contact lens parameters, accessing the first portion by an eye care provider through a first internet enabled device, specifying contact lens parameters by the eye care provider into the first portion, associating the contact lens parameters with a code, storing the contact lens parameters in the database and providing the code to the patient. The method also includes providing a second portion in the application for use by the patient, the second portion having a user interface for inputting the code and ordering contact lenses, accessing the second portion by the patient through a second internet enabled device, inputting the code by the patient into the second portion, associating the contact lens parameters entered by the eye care provider with the code, displaying the contact lens parameters to the patient and ordering contact lenses through the application by the patient.

According to another aspect, a method includes accessing a cloud-based service by an eye care provider, entering by the eye care provider contact lens parameters for a patient into the cloud-based service, storing the contact lens parameters for a patient in a database associated with the cloud-based service, associating a code with the patient, providing the code to the patient by the eye care provider, accessing the cloud-based service by the patient, receiving the code from the patient through the cloud-based service, displaying the contact lens parameters to the patient in response to receiving the code; and receiving an order for contact lenses from the patient.

### BRIEF DESCRIPTION OF THE FIGURES

FIG. 1 is a flow diagram of a process.

FIG. 2 is a block diagram which provides an overview of the system and process and the interconnection of components of the system.

FIG. 3 is an example of a home screen display associated with a mobile app that allows a user to login or specify that are a new user.

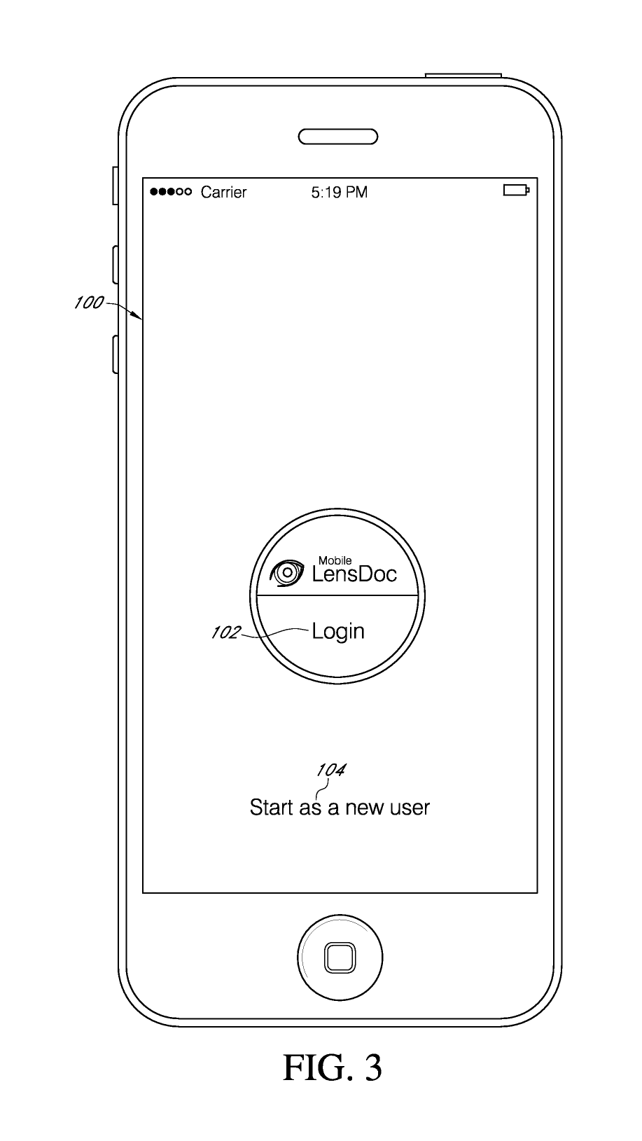

FIG. 4 is an example of a new user screen display associated with a mobile app that allows a user to scan or manually enter a code, or otherwise identify themselves as a care provider.

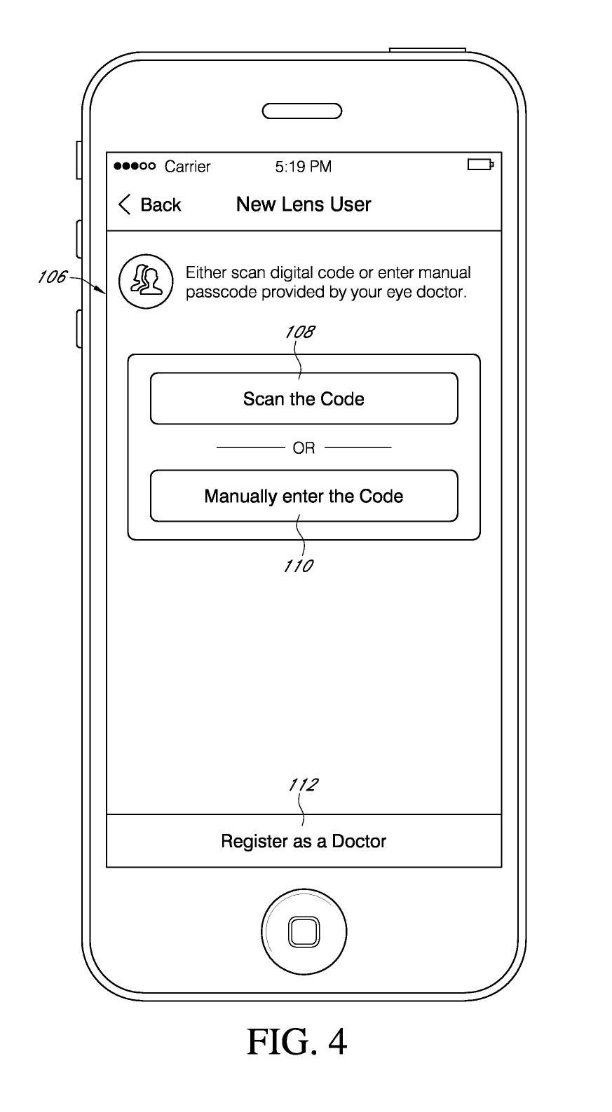

FIG. 5 is an example of a verification screen display associated with a mobile app that allows a user to verify a scanned in code is correct or manually enter the code.

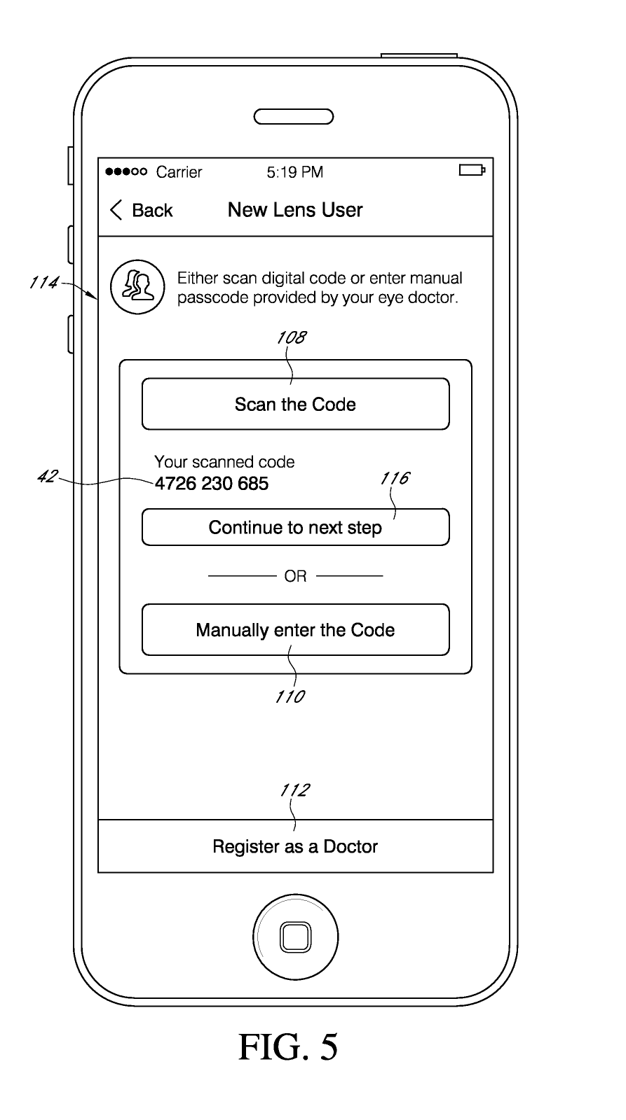

FIG. 6 is an example of a setup account screen display associated with a mobile app that allows a user to enter their email and password.

FIG. 7 is an example of a setup account screen display associated with a mobile app that allows a user to enter their address.

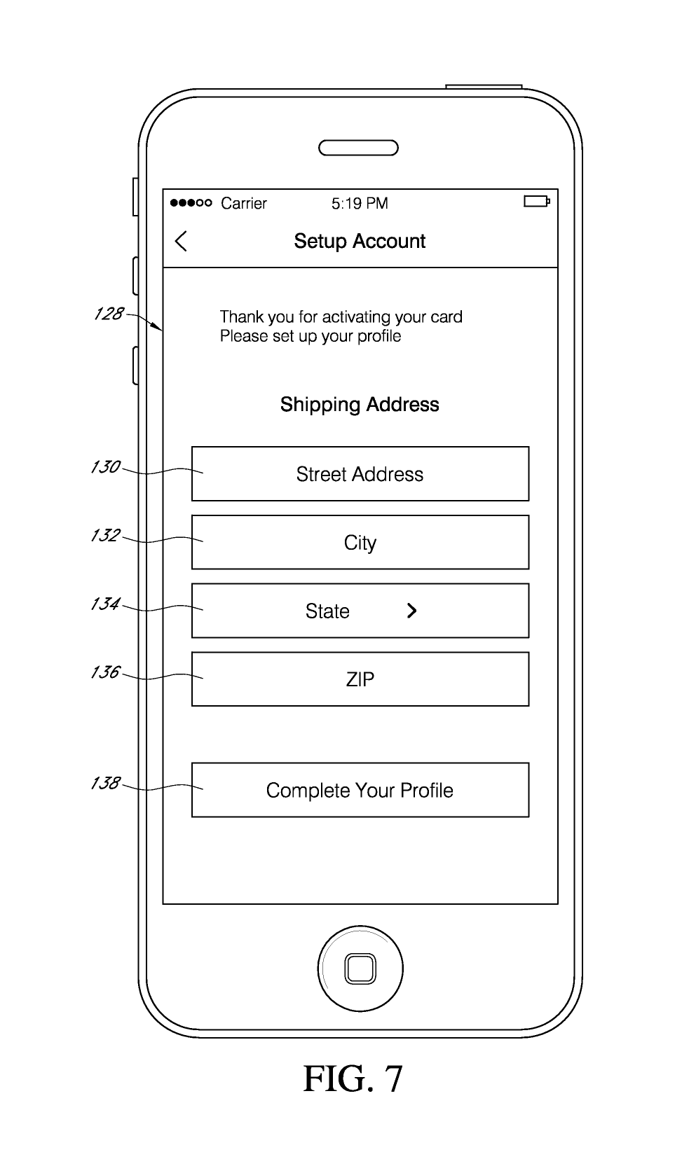

FIG. 8 is an example of a login screen display associated with a mobile app that allows an existing user to login into the app.

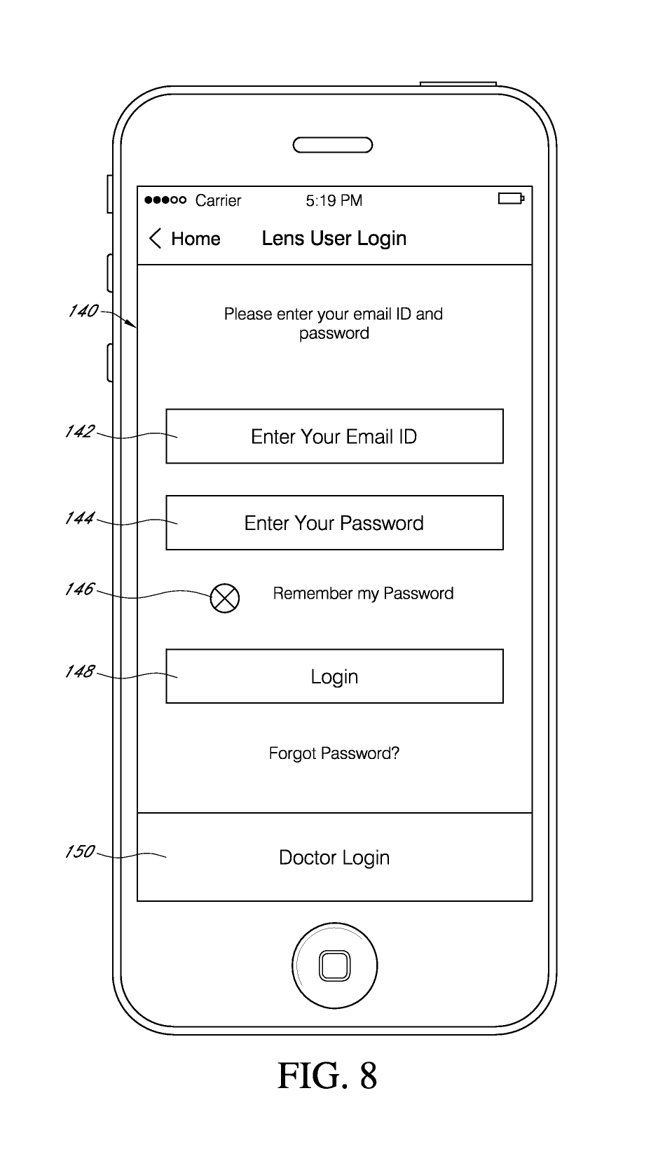

FIG. 9 is an example of a user dashboard screen display associated with a mobile app that presents the user with a plurality of options.

FIG. 10 is an example of an order contacts screen display associated with a mobile app that presents the user with their contact prescription and contact parameters after entry of the passcode and active verification, this screen allows the user to conduct a manual verification to ensure the prescription displayed on the application matches the prescription provided to the patient by the eye care provider.

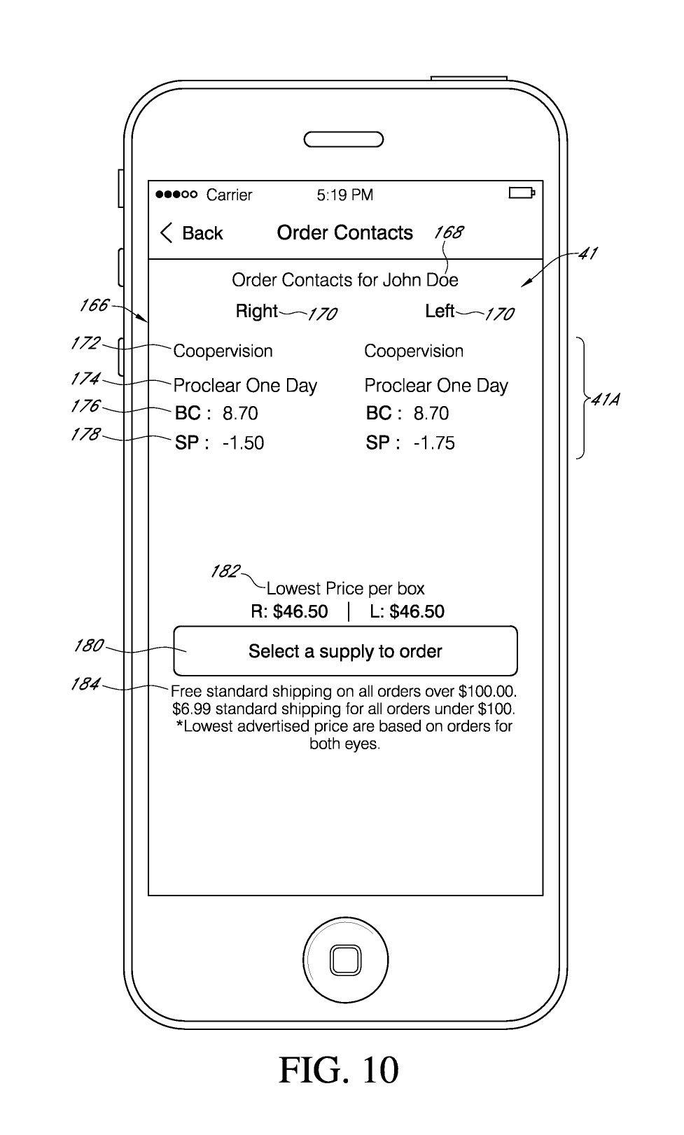

FIG. 11 is an example of an order contacts selection screen display associated with a mobile app that presents the user with various options for ordering contacts, including the quantity to purchase as well as the shipping method.

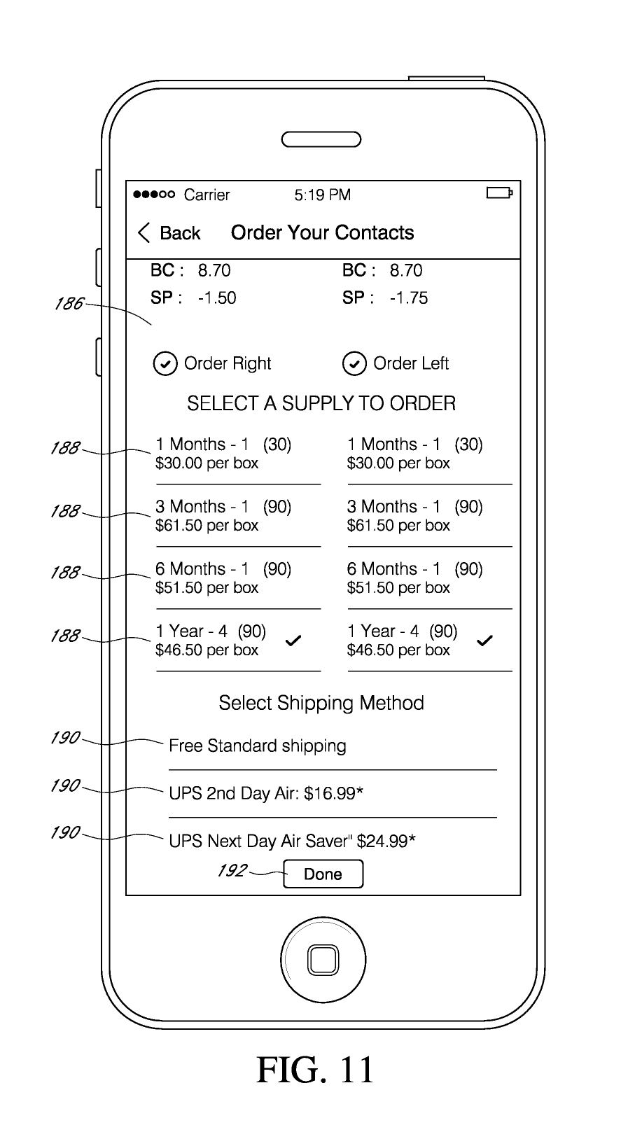

FIG. 12 is an example of an order summary screen display associated with a mobile app that presents with a summary of the contacts order and allows them to proceed to payment options.

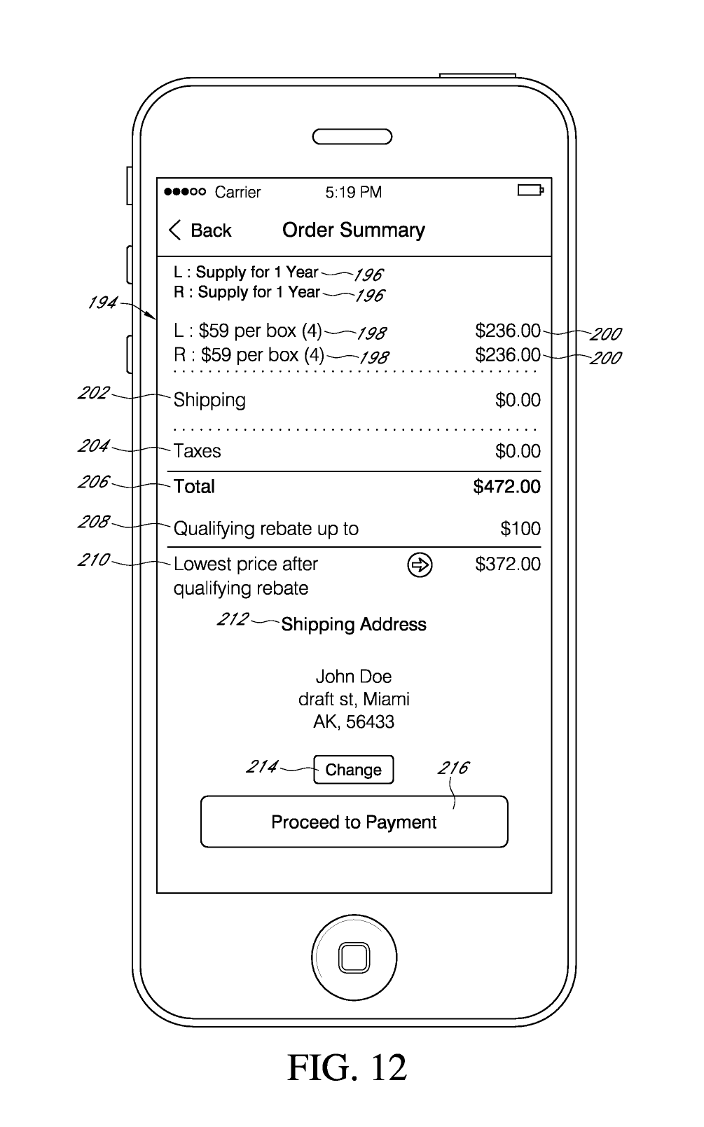

FIG. 13 is an example of a payment screen display associated with a mobile app that presents the user with a plurality of payment options.

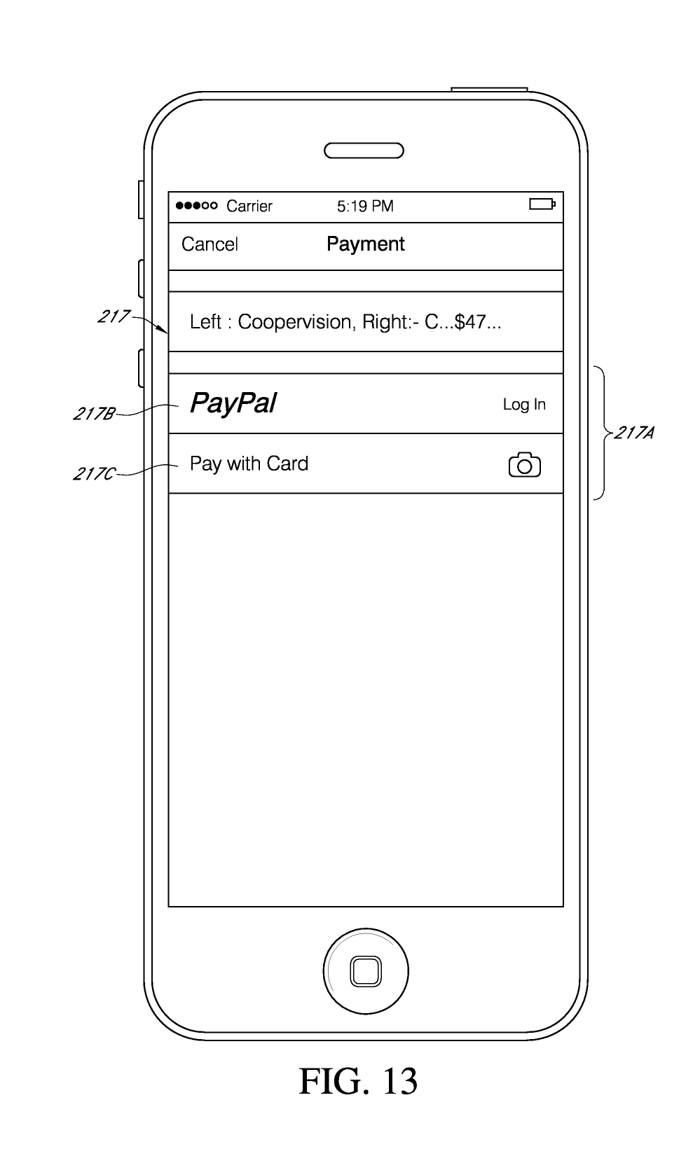

FIG. 14 is an example of a contacts clock screen display associated with a mobile app that presents the user with a contact clock.

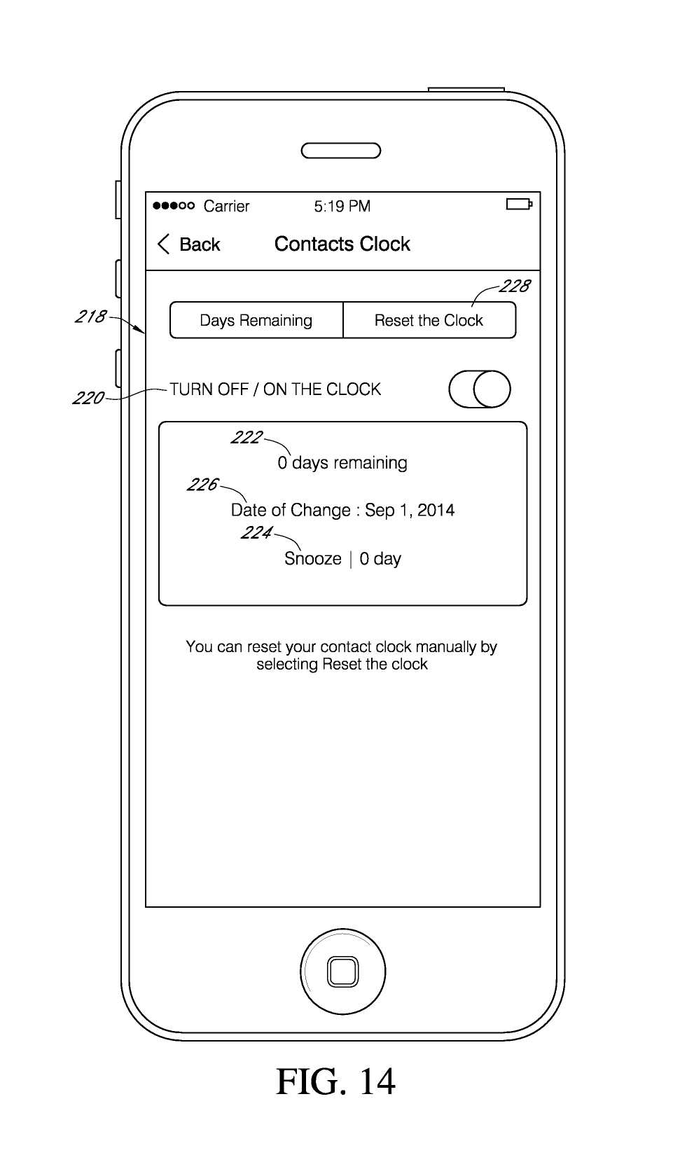

FIG. 15 is an example of a user more screen display associated with a mobile app that presents the user with a plurality of other options for the application.

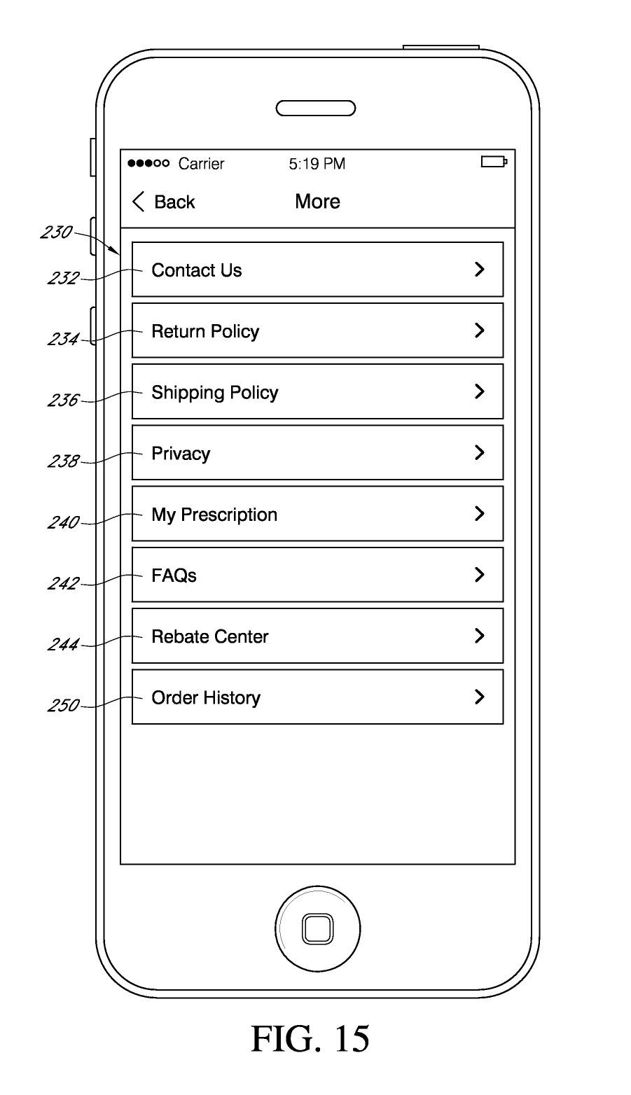

FIG. 16 is an example of a rebate center screen display associated with a mobile app that presents the user with a plurality of rebate options.

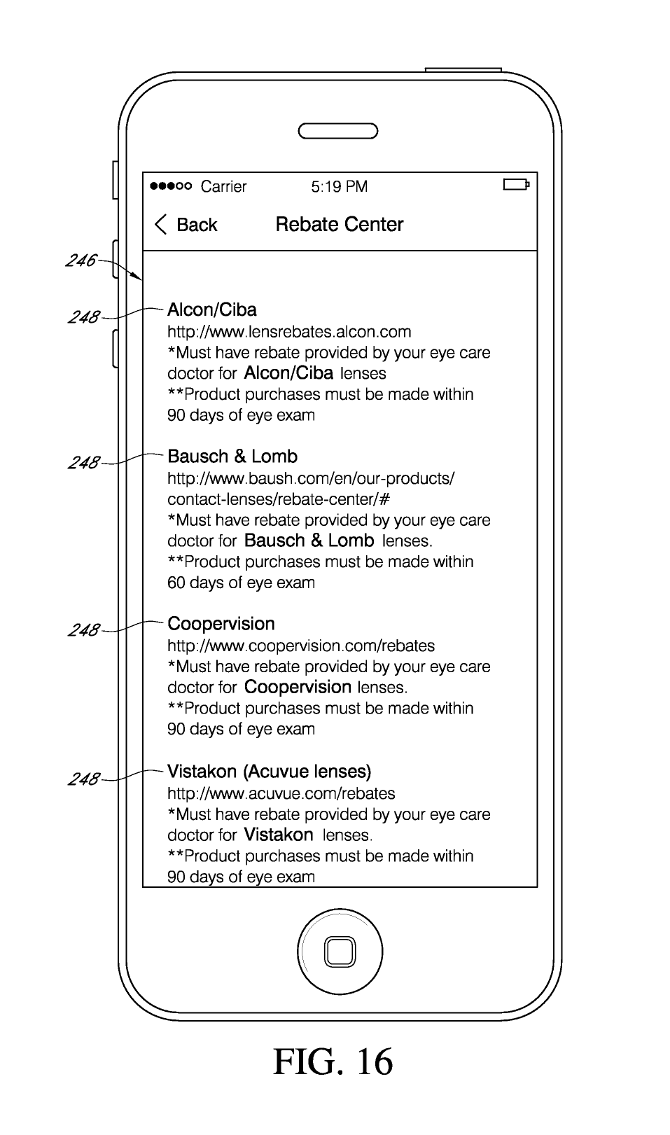

FIG. 17 is an example of a care provider login screen display associated with a mobile app that presents allows the care provider to login.

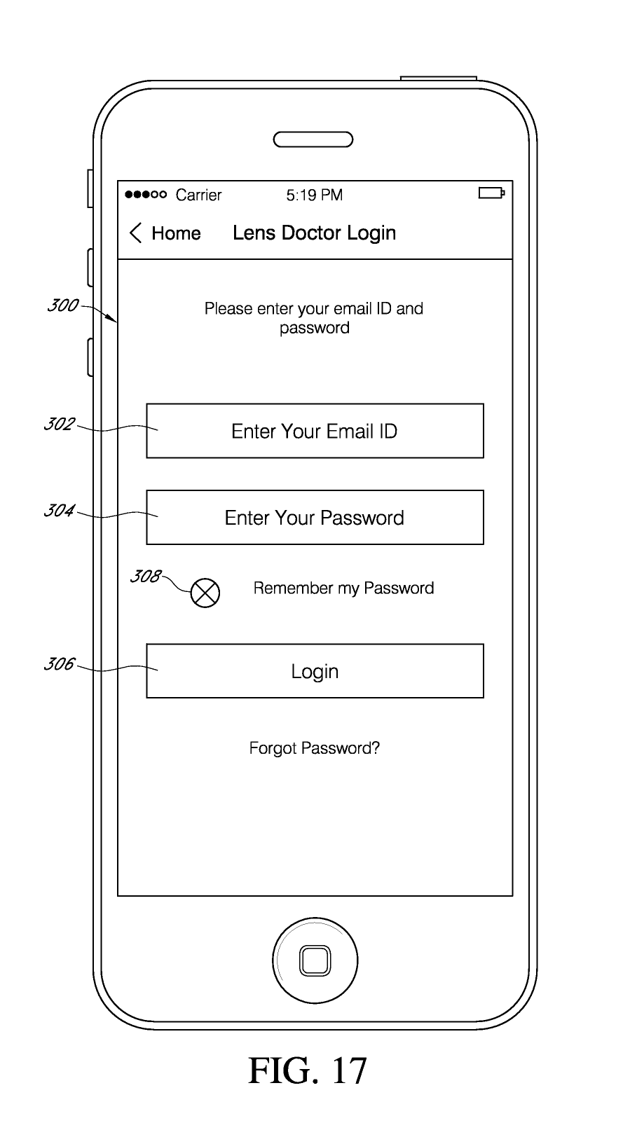

FIG. 18 is an example of a care provider dashboard screen display associated with a mobile app that presents a plurality of options for the care provider.

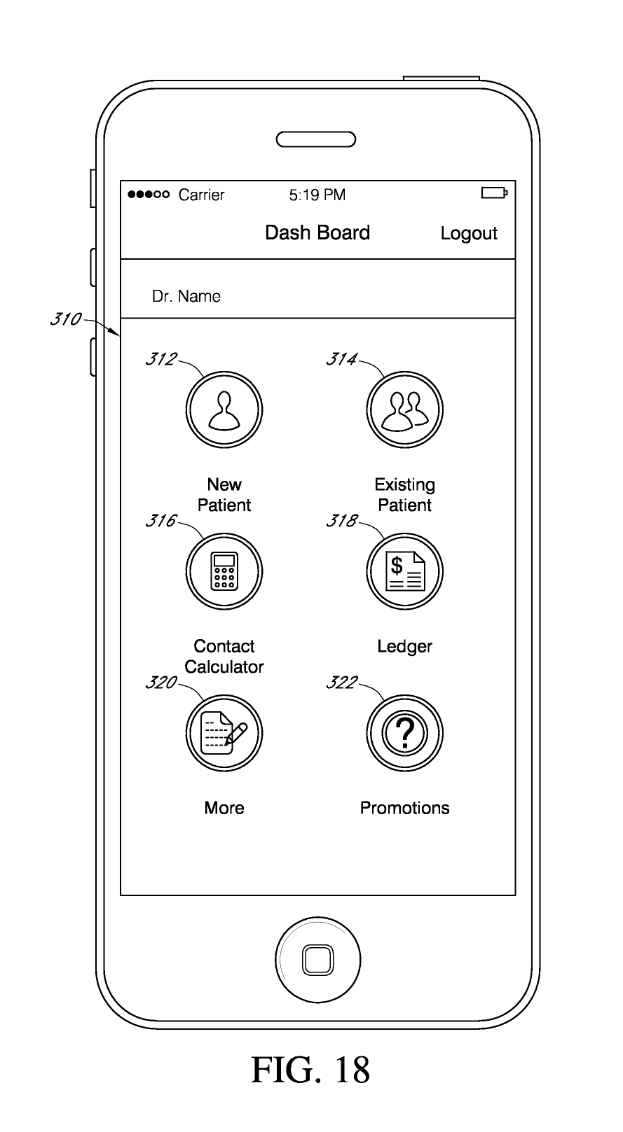

FIG. 19 is an example of a new patient screen display associated with a mobile app that allows a care provider to enroll a new patient into the application.

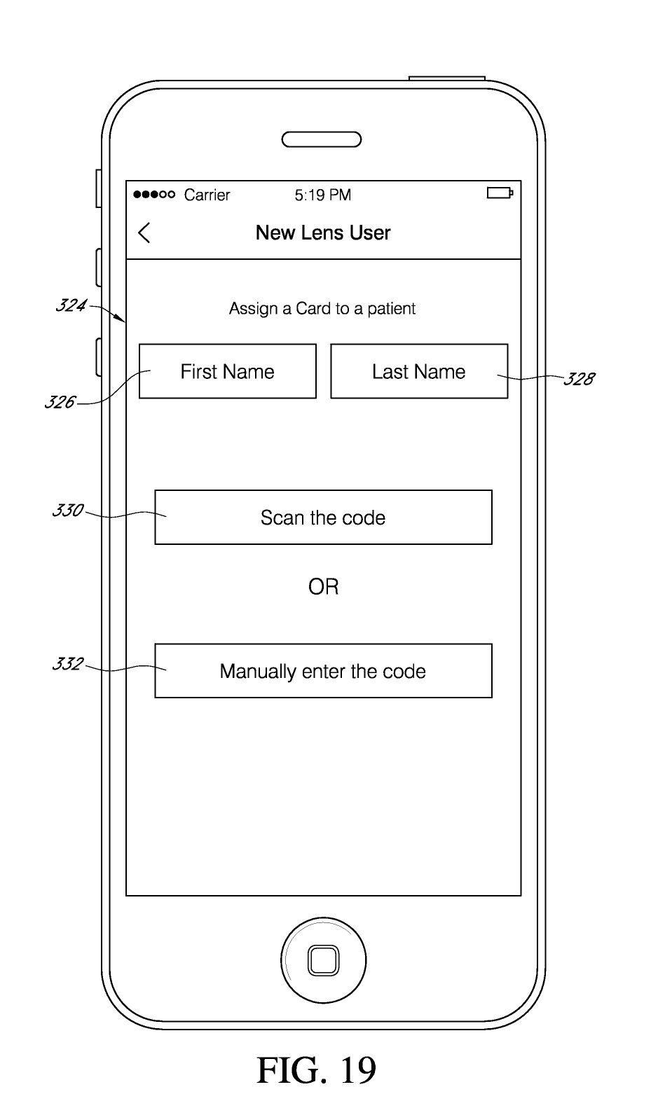

FIG. 20 is an example of a parameters screen display associated with a mobile app that allows a care provider to enter contact lens parameters for a patient.

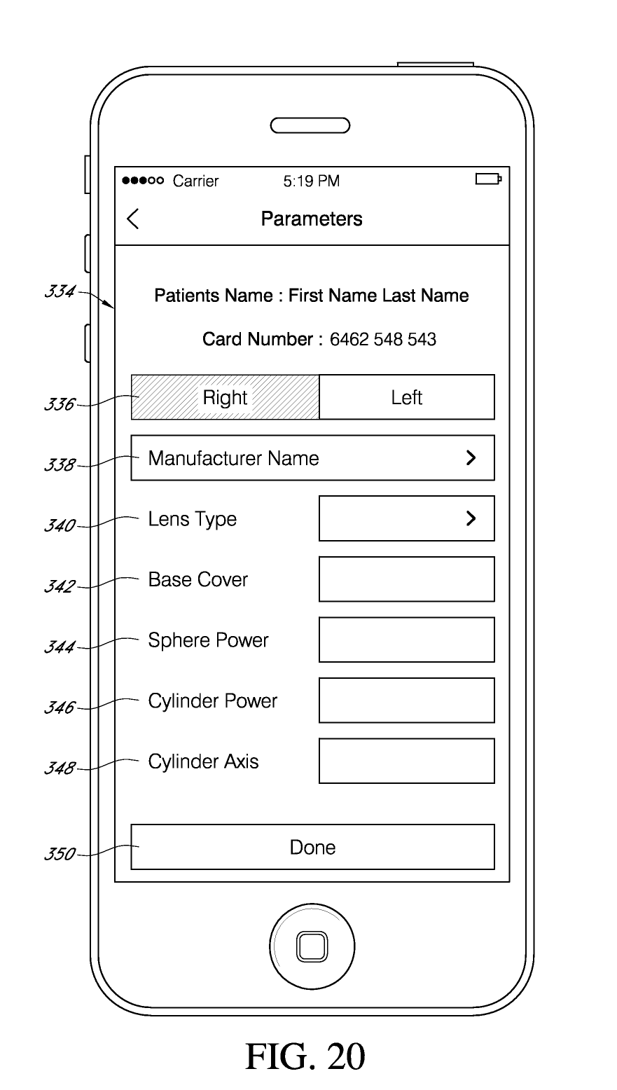

FIG. 21 is an example of an existing patients screen display associated with a mobile app that allows a care provider enter an existing patient account to add a new prescription.

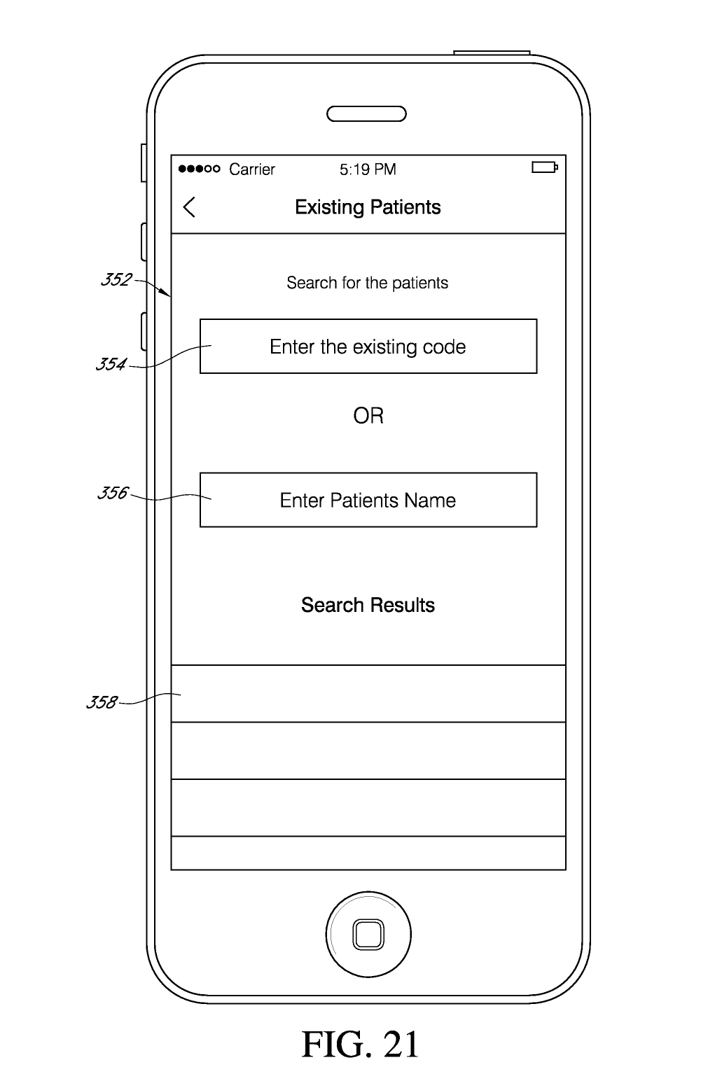

FIG. 22 is an example of a first screen of a contact calculator screen display associated with a mobile app that allows a care provider calculate contact lens parameters to determine the proper contact lenses to prescribe.

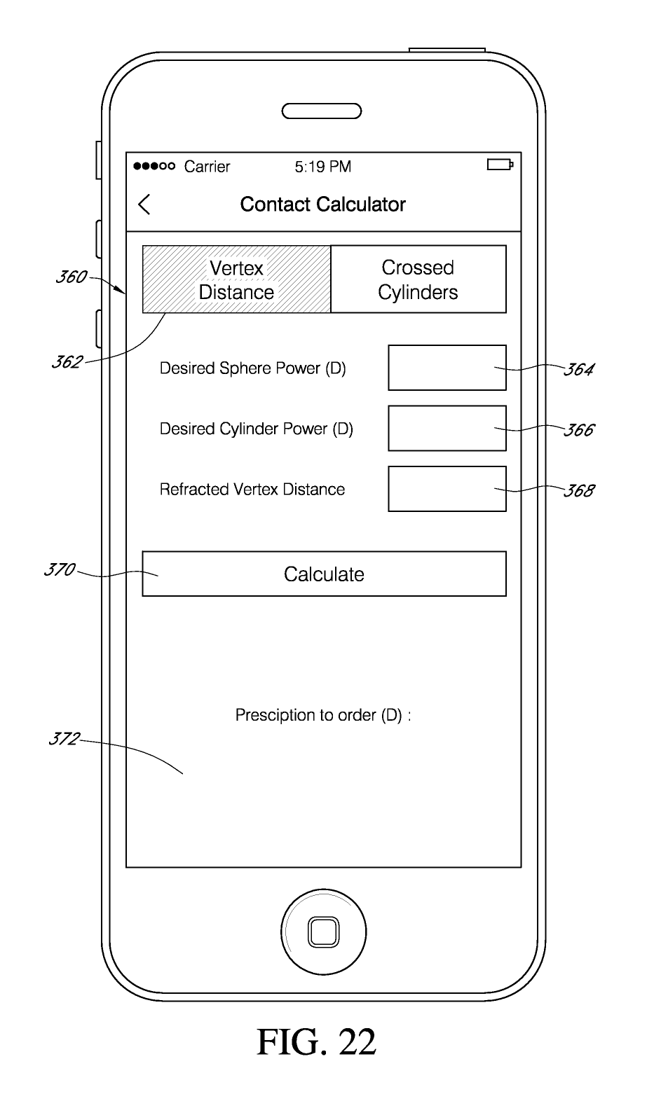

FIG. 23 is an example of a second screen of a contact calculator screen display associated with a mobile app that allows a care provider calculate contact lens parameters to determine the proper contact lenses to prescribe.

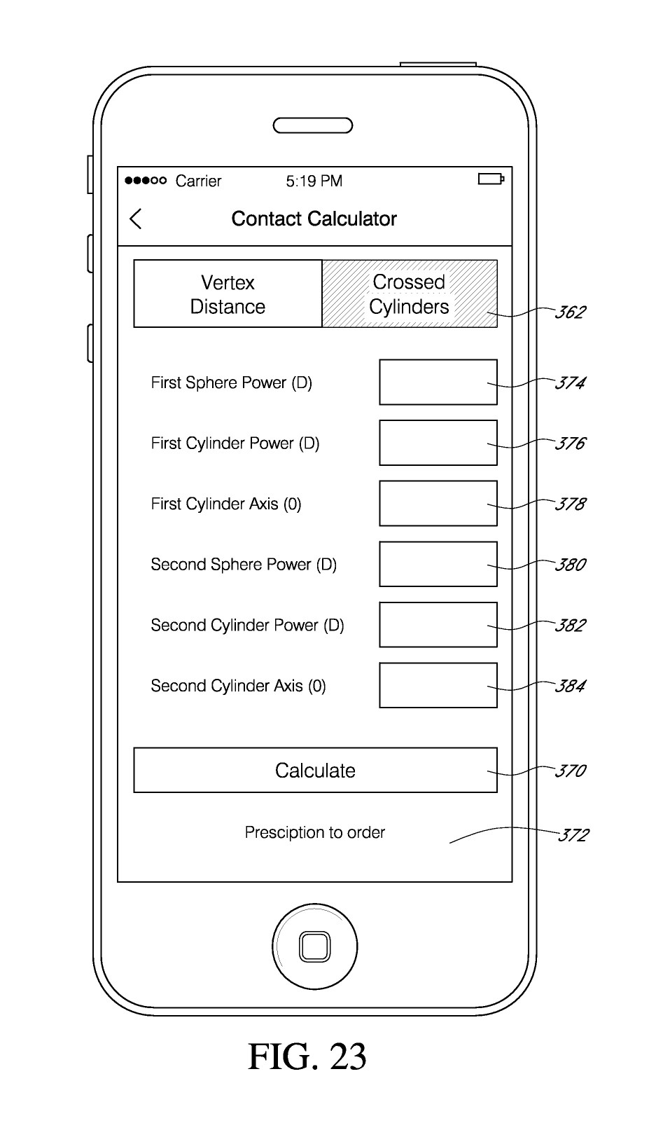

FIG. 24 is an example of a ledger screen display associated with a mobile app that allows a care provider see their activity on the application.

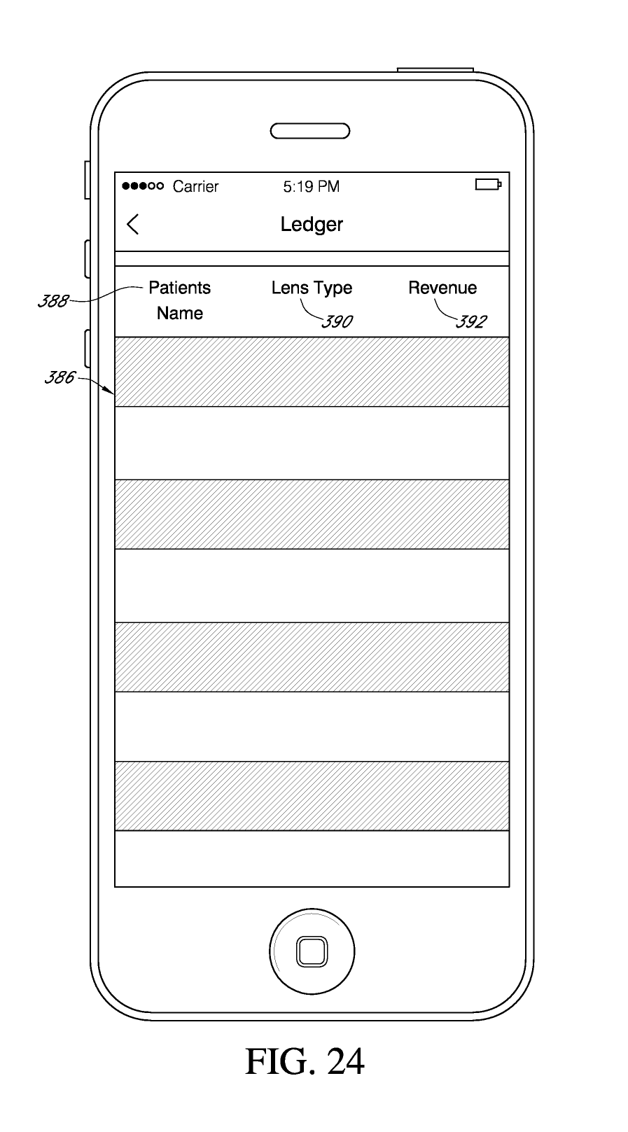

FIG. 25 is an example of a care provider more screen display associated with a mobile app that presents the care provider with a plurality of other options for the application.

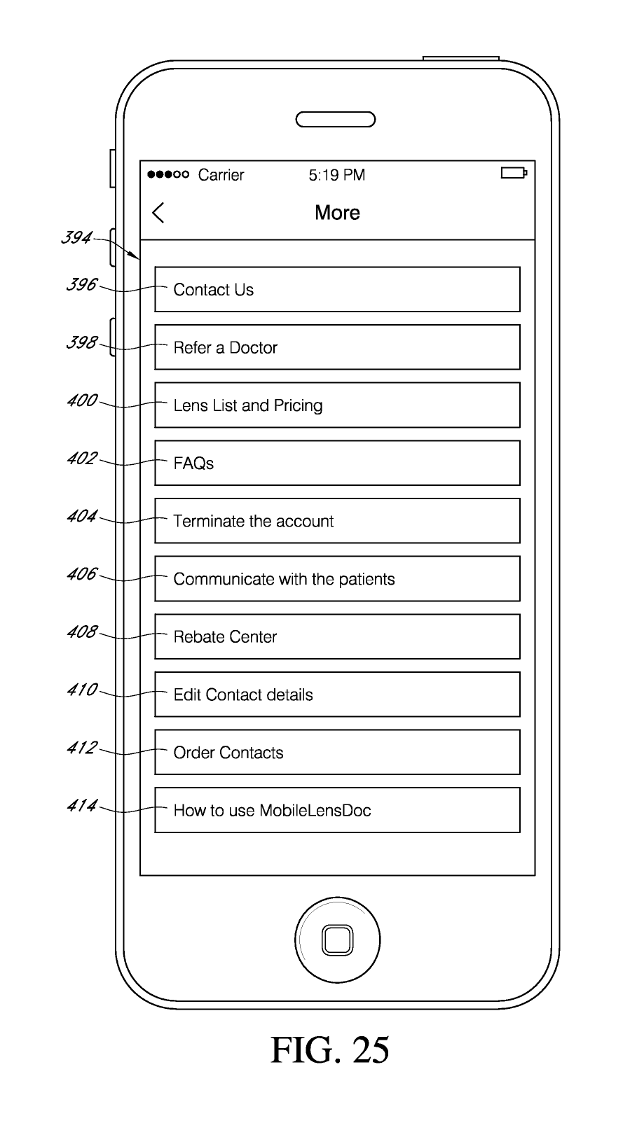

FIG. 26 is an example of a card layout including a passcode in manual and scannable form thereon associated with a mobile app that allows both the care provider and the patient/user to enter or scan in the code for use with the system as is described herein.

### DETAILED DESCRIPTION OF THE PREFERRED EMBODIMENT

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention(s) is defined only by the appended claims, along with the full scope of equivalents to which such claims are entitled.

As used herein, the invention is shown and described as being used primarily in association with the prescription of contact lenses by an eye care provider and ordering of contact lenses by a patient. However the invention is not so limiting. Instead, one of ordinary skill in the art will appreciate that the system and method presented herein can be used, and therefore is contemplated for use, with any and all controlled substances or devices and prescribed substances or devices. The system and method is merely shown and described as being used in association with an eye care provider and with contact lenses as one of countless examples.

With reference to the figures, the invention may include a mobile application or app such as may be used on a mobile device, or any internet enabled device. The app may be a native application to an operating system such as to Apple iOS, Android, Windows Phone, Windows RT, Asha, Blackberry or any other system or the like. Alternatively the app may be a non-native application such as based on HTML5 or any other alternative. The mobile application may be free to download to patients and doctors. The app may provide for layered passcode encryption, high functionality, and local push notification.

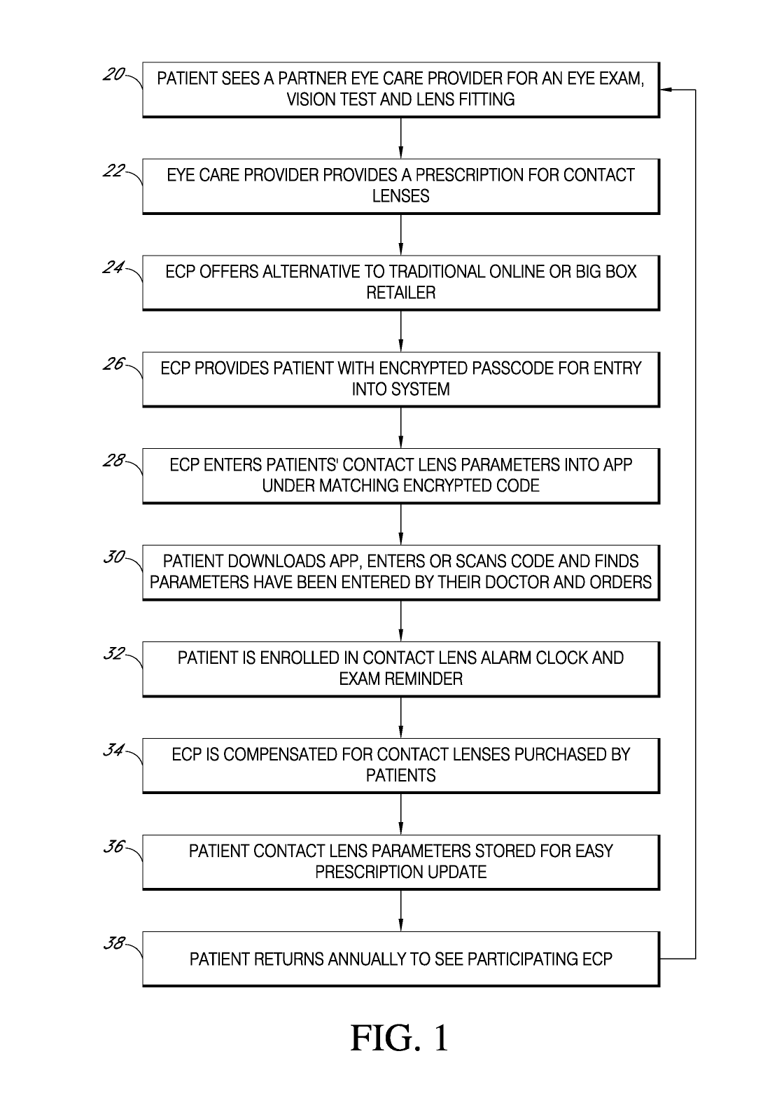

FIG. 1 provides a rough flow diagram of one example of a process, or system. In step 20 a patient visits a partner eye care provider (ECP) for an eye exam, a vision test and a contact lens fitting.

In step 22, the eye care provider provides the patient with a prescription for contact lenses. This prescription can be fulfilled in-house by the eye care provider, or alternatively the patient can seek to fulfil the prescription through other means.

In step 24, the eye care provider offers the system or method of the invention as an alternative to other types of contact lens buying such as traditional online ordering or big box retailers.

In step 26, the eye care provider provides the patient with a passcode for entry into a mobile application. In one arrangement the passcode is on a document, a sheet of paper, a card, a sticker, the prescription or other document provided to the patient at step 26. In one arrangement the passcode is a manual code such as standard text letters, numbers and/or characters. In another arrangement, the passcode is contained within a scannable code such as a bar code, QR code, a 2D-code, an optical code, a near-field communication (NFC) code or any other electronically perceivable code. In one arrangement the passcode is encrypted. Encryption is the process of encoding one or more messages, codes or information in such a way that only authorized parties can read or process the message, code or information. In one arrangement, the plain-text passcode is encrypted within the scannable code. In another arrangement, both the passcode and the scannable code are encrypted. In yet another arrangement, neither the passcode nor the scannable code are encrypted.

In step 28, the eye care provider enters the patient's contact lens parameters (or prescription) into a mobile application and associate's the contact lens parameters with the passcode. The contact lens parameters include any information or requirements needed to purchase the proper contact lenses for the patient. This information may include any of the manufacturer type, size, power, material, design, style, BC, SP, special requirements or the like. In step 28 the eye care provider themselves or the application itself associates the passcode with the patient, prescription and/or with the contact lens parameters. In one arrangement, this can be done by manually entering the passcode or by scanning the passcode on the card provided to the patient. It is hereby contemplated that either step 26 or step 28 can precede one another.

In step 30, the patient downloads the application, enters the passcode, by manual entry, scanning or another method, which serves as the key to open the door to gain admission into the application. Once in the application, the patient enters patient information such as name, address, payment information, email address, user name, password and the like to establish what will be a username and password protected patient account. In response to inputting this passcode that application searches based upon this code for any matching or corresponding passcodes entered by an eye care provider and associated with a prescription or contact lens parameters. Once the application has verified that the passcode inputted by the patient matches or corresponds to a passcode (with an associated prescription or contact lens parameters) entered by an eye care provider the application displays contact lens parameters or prescription to the patient. Displaying this information to the patient allows the patient, should they so desire, to review the prescription or contact lens parameters displayed by the application and compare it to the information provided to them by their eye care provider to ensure it is accurate. Next, the patient can select various variables associated with the contact lens order such as quantity and type of shipping. Next the patient can now order contact lenses through the mobile device at any time prior to expiration of their prescription (e.g. one year). Payment may be made through a payment processor such as a credit card, PayPal, bitcoin or the like.

In step 32, the patient is or has the option to be enrolled in a contact lens alarm clock and an exam reminder. The contact lens alarm clock displays a message on the patient's mobile device at specified intervals reminding the patient that the contact lenses should be replaced. As one example, if the patient uses 30-day contacts, a replacement reminder is sent every 30-days reminding the patient to replace their contacts. In addition, the application sends exam reminders to the patient at predetermined intervals reminding the patient to schedule an appointment with the eye care provider. As one example, this message is sent one, two or three months before the anniversary of the last eye exam. In one arrangement, the patient communicates directly with the eye care provider through the application and schedules their next appointment. In addition, the application sends messages to the patient from the eye care provider, such as information about the eye care provider, information about eye health and maintenance, appointment reminders, new products, and any other information or messages desired to be sent by the eye care provider to the patient. This communication portal assists in obtaining patient compliance with contact lese replacement schedules by providing reminders on their mobile devices and also strengthens the relationship between the patient and eye care provider and secures the eye care provider's client base.

In step 34, the eye care provider is reimbursed or remunerated for contact lenses purchased by their patients. As one example, a portion of the purchase price for the contact lenses ordered is transmitted to a financial account associated with the eye care provider's account with the application. In one arrangement, this portion of the purchase price is the full mark-up of the ordered products. In another arrangement, this portion of the purchase price can be a flat fee, a set percentage of the purchase price, or any other compensation scheme.

In step 36, the patient contact lens parameters are stored in a database associated with the application for easy prescription updates for the prescribing eye care provider in future years.

In step 38, the patient returns periodically (annually or otherwise) to see their participating eye care provider and the process is repeated starting at step 20.

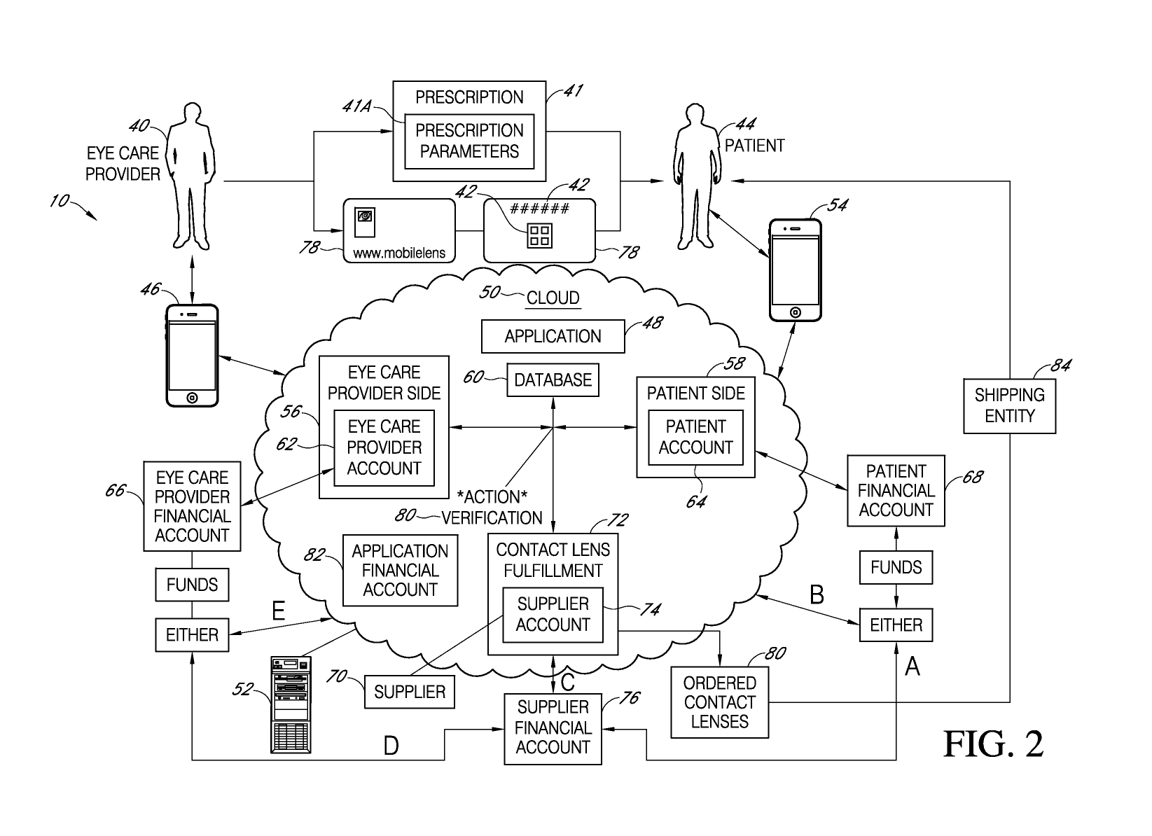

FIG. 2 provides an overview of one embodiment of a system 10. As shown in FIG. 2, there is an eye care provider 40 and a patient 44. The term eye care provider is meant to be broadly construed and includes any person, group of persons, organization or the like that provides eye care to a patient. Similarly the term care provider is meant to be even more broadly construed and includes any person, group of persons, organization or the like that provides care to a patient.

The eye care provider 40 examines the patient 44 and provides a prescription 41 to the patient 44 that includes contact lens parameters 41A such as manufacturer type, size, power, material, design, style, BC, SP, special requirements or the like for each eye. Thereafter, the eye care provider 40 provides the patient 44 with a passcode 42. In one arrangement, the passcode 42 is contained on a document such as a card (such as a business card) and can be in one or both of the forms of a manual code such as standard text letters, numbers and/or characters and/or a scannable code such as a bar code, QR code, a 2D-code, an optical code, a near-field communication (NFC) code or any other electronically perceivable code.

The eye care provider 40 uses an internet enabled device or mobile device 46 with an application 48 installed and executing on the device 46. In one arrangement, the application 48 is a set of software instructions which is stored on a non-transitory computer readable storage medium. The device 46 is connect through an electronic network, internet or a cloud 50 to a server 52. It is to be understood that the server 52 need not be a single machine but may include more than one machines connected and interconnected to one another through a series of wired and/or wireless networks.

Similarly, the patient 44 uses an internet enabled device or mobile device 54 with application 48 installed and executing on the device 54. Like the eye care provider's device 46, the patient's device 54 is connected through an electronic network, internet or a cloud 50 to a server 52. It is to be understood that the server 52 need not be a single machine but may include more than one machines connected and interconnected to one another through a series of wired and/or wireless networks.

In the arrangement shown, application 48 is a web-based, cloud-based or internet-based system. Meaning, in part, that the application 48 exists partially on the cloud 50, the server 52, the eye care provider's device 46 and the patient's device 54. In the arrangement shown, application 48 includes a first portion or care provider portion or care provider portal 56 and a second portion or patient portion or patient portal 58. Portions of the application 48 are stored in memory of the respective care provider's device 46 and memory of the respective patient's device 54, and portions of the application 48 are stored on the server 52 or on one or more databases 58 associated with the application 48. These individual modules communicate with one another through the electronic networks such as the internet or the cloud 50, and exchange information in the manners described herein.

In the arrangement shown, first portion or care provider portion or care provider portal 56 includes an eye care provider account 62, which includes information regarding the eye care provider 40 including the eye care provider's personal name, practice name, physical address, email address, prescribing authority, username, password and any other information necessary for the application 48 to operate. Similarly, second portion or patient portion or patient portal 56 includes a patient account 64, which similarly includes information regarding the patient 44 including the patient's personal name, physical address, email address, username, password and any other information necessary for the application 48 to operate.

An eye care provider financial account 66 is associated with the eye care provider account 62. Similarly, a patient financial account 68 is associated with the patient account 64. These financial accounts 66, 68 are any form of an account in which monetary funds or non-monetary credits can be added to or withdrawn from through electronic transactions, debits or credits. Examples of such financial accounts include bank accounts, checking accounts, credit card accounts, PayPal accounts, Bitcoin accounts, and any other types of monetary accounts. Examples of non-monetary accounts include loyalty accounts, discount accounts, points or frequent-flyer-type accounts, or any other non-monetary account.

In the arrangement shown, a contact lens fulfillment supplier 70 is also associated with the application 48. Contact lens fulfillment supplier 70 is any entity that manufactures, sells, ships or distributes contact lenses in response to orders received through the application 48. Supplier 70 is associated with a third portion or supplier portion or supplier portal 72 in the application 48 that includes an supplier account 74, which includes information regarding the supplier 70 including the supplier's name, physical address, email address, username, password, the products they carry, the prices for the products they carry, delivery times, and any other information necessary for the application 48 to operate.

A supplier financial account 76 is associated with the supplier account 74. The supplier financial account 76 is like or similar to the previously described financial accounts 66, 68 in that it is any form of an account in which monetary funds or non-monetary credits can be added to or withdrawn from through electronic transactions, debits or credits as is described herein.

Any number of accounts, either supplier 70, patient 44 and/or eye care provider 40 can be established through the application 48 in the manner shown.

In the arrangement shown, the eye care provider 40 provides a prescription 41 to the patient 44 after an eye exam. Simultaneously, the eye care provider provides a passcode 42 to the patient 44. In the arrangement shown, this passcode 42 is contained on a card, sticker, the prescription itself or other document 78. Next, the eye care provider 40 opens the eye care provider portion 56 of application 48 on their mobile device or internet enabled device 46 and enters the prescription parameters 41 into the application 48. The prescription parameters 41A are associated with the passcode 42 either by the application 48 itself automatically, or by the eye care provider 40 scanning in or imputing the passcode 42 using their device 46. This information is then stored in database 60 of application 48.

When the patient 44 desires to order contact lenses through the application 48 the patient 44 accesses the internet using their mobile device or internet enabled device 54, they download the patient portion 58 of the application 48 and establish a patient account 64 and associate a patient financial account 68 with their patient account 64. The patient 44 then inputs or scans the passcode 42 using their device 54 which is transmitted to application 48 through the internet, wireless network or cloud 50. Application 48 decodes this passcode 42 and compares it to passcodes previously entered by eye care providers and if it corresponds to or matches a passcode previously entered by an eye care provider 40 and the prescription associated with that passcode 42 has not expired then the step of active verification 80 has occurred and the prescription 41 is verified and the prescription parameters 41A are displayed to the patient 44 on their device 54 in the patient portal 58.

Once verified and displayed to the patient 44, the patient 44 selects from various options for fulfillment, such as quantity, manufacturer, shipping, etc. and the patient 44 orders the contact lenses. This order is transmitted through the electronic network, internet or cloud 50 and the funds are debited from the patient's financial account 68. The order is submitted to the supplier 70 and the supplier ships the ordered contact lenses 80 to the patient 44.

Financial Routing:

In one arrangement, the entirety of the funds debited from the patient's financial account 68 are deposited directly or indirectly in the supplier's financial account 76. From there, a portion of the funds are transmitted to, or otherwise retained within, the eye care provider's financial account 66 for utilizing the application 48. In one arrangement, the full mark-up of the ordered products less licensing fees or user fees and processing and handling fees are distributed to, or otherwise retained within, the care provider' financial account 66 as an incentive to use the system 10. In another arrangement, this portion of the purchase price can be a flat fee, a set percentage of the purchase price, or any other compensation scheme. In one arrangement, a portion of the funds are transmitted to the application financial account 82 associated with the application 48 as a transaction fee, licensing fee, handling fee, use fee or otherwise known as retained fee. In an alternative arrangement, the entirety of the funds debited from the patient's financial account 68 are deposited directly or indirectly in the application's financial account 82. From there, the purchase price portion of the funds are transmitted to supplier's financial account 76 for payment for the contact lenses 80 and a portion of the funds are transmitted to the eye care provider's financial account 66 as the benefit of or incentive for utilizing the application 48 with the remaining balance of funds being retained in the application financial account 82 as a transaction fee. In addition, a portion of the funds are transmitted to a shipping entity 84 as payment for shipping the contact lenses 80 to the patient 44. These above examples are merely that, examples of the manners in which funds are distributed through the system 10. Any other manner or method of transmitting money between the entities described herein is hereby contemplated for use, including the use of any third party intermediary institution or accounts as well as any manner or form of transactions between these various institutions or accounts or the like.

In an alternative arrangement, the eye care provider 40 pays a monthly, yearly or one-time licensing fee for use of the application 48. This allows the eye care provider 40 to retain the entirety of the mark-up of the ordered contact lenses less shipping and handling fees and the cost to purchase the contacts.

Application Screens—Patient Side of the Application:

As one example, upon opening the application on an internet enabled device 54, such as a mobile device, the user is presented with a home screen 100. The home screen 100 presents the user with the option of pressing a login button 102, which is utilized by established users to login to their established accounts. The home screen 100 also presents a new user button 104 which is selected by new users to establish a new account.

New User Setup:

Upon pressing the new user button 104 the new user screen 106 is displayed. The new user screen 106 displays a scan the code button 108 as well as a manually enter the code button 110. Either of these options are selected by a new patient 44 using the application 48 which begins entry into the second portion or patient portion or patient portal 58 of application 48. When the scan the code button 108 is pressed, the patient's mobile device 54 automatically opens a scanning function and the mobile device 54 is used to scan or capture the passcode 42 contained on the card or document provided to the patient 44 by the eye care provider. The scanning function automatically decodes the encrypted code and transmits it through the electronic network, internet or cloud 50 to the application 48 where it is correlated to or matched with the passcodes stored in database 60 and assigned to eye care providers 40 and associated with prescriptions 41, prescription parameters 41A and/or patients 44 by eye care providers 40. If a correlation or match is found an active verification occurs and the process continues as is described herein. In the event that the patient 44 is unable to scan the code, the user presses the manually enter the code button 110 and enters the code 42, which begins the same procedure described herein.

Alternatively, if the new user is an eye care provider, the new user eye care provider selects the register as a doctor button 112 which begins the process for registering as an eye care provider, as is further described herein.

Once the code 42 is successfully scanned in or manually entered a verification screen 114 is presented which presents the code 42 for verification by the patient 44. The patient 44 then compares the passcode 42 displayed on the screen with the plaintext passcode 42 on the card 78 and if the two passcodes 42 match, the user then selects the continue-to-the-next-step button 116. This is the first verification process, which is performed by the patient 44 themselves.

Once the plain text passcode 42 is verified, the patient 44 is shown to the setup account screen 118 for a new user. On this setup account screen 118 the new user is prompted with an enter email box 120, wherein the new user enters their email address, a create password box 122, wherein the new user enters their password, and a 124, wherein the new user repeats their password. The patient 44 is then presented with a continue-to-next-step button 126. Upon pressing the continue-to-next-step button 126, the application 48 compares the two entered passwords to ensure they match. In the event that the two entered passwords match, the user is transmitted to the next screen.

Upon pressing the continue-to-next-step button 126 a second setup account screen 128 is presented. The second setup account screen 128 presents entry fields or boxes requesting the new user to enter their address. These include a street address box 130, a city box 132, a state box 134 and a zip code box 136. In one arrangement, the state box 134 is prepopulated with all the states and therefore the user can select the correct state. Similarly, in one arrangement, the zip code box 136 is interactive and self populates based on the information entered into the other entry fields 130, 132, 134. Once the new user has successfully entered their information into these fields, the user selects the complete your profile button 138, which completes the new user setup process.

Existing User Login:

Alternatively, when on the home screen 100, if the user is an existing user, the existing user selects the login button 102. Upon pressing the login button 102 the existing user is presented with the login screen 140. The login screen 140 includes an enter-your-email ID box 142 and an enter-your-password box 144 wherein the existing user is to enter their username or email address and password, respectively.

The login screen 140 also includes a remember-my-password button 146, which when selected remembers the user's username and/or password to their device 54. Alternatively, when the remember-my-password button 146 is selected the application 40 remembers the user's username and password and automatically logs them in upon pressing the login button 102 on the home screen 100 the next time the user visits the application 48, or alternatively automatically logs them in upon opening the application 48 on their device 54.

Once this information is entered, the user selects the login button 148 to login to the application 48. The login screen 140 also includes a doctor login button 150 which is selected by an eye care provider existing user, as is further described herein with respect to the eye care provider section of the application 48.

Within the Application:

Once logged in, the patient 44 is presented with the dashboard screen 152 which provides the user with a plurality of options. As one example, these options include an order contacts button 154, a contacts clock button 156, a profile button 158, a settings button 160 a more button 162 and a help button 164. The order contacts button 154 is used to access the order contacts functionality of the application 48, the contacts clock button 156 is used to access the contacts clock functionality of the application 48, the profile button 158 is used to access, verify and amend the patient's profile, the settings button 160 is used to access, verify and amend the settings of the application 48, the more button 162 is used additional features and offerings of the application 48, and the help button 164 is used when assistance is needed using the application 48.

Ordering Contacts:

Upon selecting the order contacts button 154 the user is presented with the order contacts screen 166. The order contacts screen 166 presents the patient's contact lens prescription 41, including the contact lens parameters 41A. More specifically, and as one example, as is shown, the user is presented with the patient's name 168, and by eye (right/left) 170 the manufacturer 172 of the prescribed contacts, the model or type 174 of the prescribed contacts, the BC 174 of the prescribed contacts, the SC 176 of the prescribed contacts, and any other contact parameters. This information is presented to the user after the active verification process retrieved the prescription 41 and prescription parameters 41A entered by the eye care provider 40 from database 60 based on scanning or inputting the passcode 42 provided to the patient 44. Presenting this information to the user allows the user to verify that it matches the prescription 41 and prescription parameters 41A provided by the eye care provider 40 to the patient 44. As such, this is yet another verification step. If the prescription 41 and prescription parameters 41A do not match

Once the user verifies that the prescription information presented in the order contacts screen 166 is correct, the user presses the select a supply to order button 180.

Also presented on the order contacts screen 166 is the lowest price per box 182 as well as preliminary shipping information 184 or standard shipping practices and procedures information.

Upon pressing the select a supply to order button 180 the user is presented with an order contacts selection screen 186. This order contacts selection screen 186 retains all the prescription 41 and prescription parameters 41A displayed on the previous screen as well as a plurality of quantity options 188 with the associated prices. As one example, as is shown, the user is presented with the option to purchase a one month, three month, six month and one year quantity of contact lenses. This allows the user to balance the cost savings versus the benefit of having additional contact lenses at that time. Once the quantity is selected, a check mark or other indication is shown on the display verifying the selection.

In one arrangement, the cost information by manufacturer, make and quantity is populated through information transmitted by supplier 72 to application 48 through the electronic network, internet or cloud 50 and stored in database 60 which is periodically updated. In another arrangement, the cost information by manufacturer, make and quantity is populated through an active and interactive data communication between supplier 72 and application 48 through the electronic network, internet or cloud 50 which allows for real-time and constantly up-to-date information. Any other manner of populating this information is hereby contemplated for use.

The user is also presented with a plurality of shipping options 190. These shipping options 190 are interactive and related to the quantity selected because the size of the boxes may change which affects the shipping costs and as an incentive to order additional contacts at once shipping prices may be gratis or reduced for larger orders. Once the shipping method is selected, a check mark or other indication is shown on the display verifying the selection. As examples, shipping options 190 include free standard ground shipping, second day air shipping, next day air shipping, and the like.

Once the quantity and shipping has been selected and verified by the user, the user selects the done button 192.

Once the done button 192 has been selected, the user is presented with the order summary screen 194. The order summary screen 194 summarizes the order. As one example, as is shown, it presents the quantity of contacts selected in both length of time 196 as well as number of boxes 198 and the cost 200 for these contact lenses. It also reiterates the shipping cost 202 and presents the tax cost 204. The order summary screen 194 also presents a total order cost 206 and any qualifying rebate 208 that may apply to the order. Based on this information, the user is presented with the lowest price after qualifying rebate 210. The user's shipping address 212 is presented, which is retrieved from the user profile entered during the set up process described herein. The user is also presented with a change address button 214 in the event that they want the order to be shipped to a different address than that which was previously entered and stored in the application 48. Once the user verifies all of the information is correct, the user selects the proceed-to-payment button 216.

Once the user selects the proceed-to-payment button 216 the user is presented with the payment screen 217. On the payment screen 217 the user is presented with a plurality of payment options 217A. As one example, the user is presented with a pay with PayPal option 217B, which when selected allows the user to login to their PayPal account in the ordinary and standard manner as is known in the art. As another example, the user is presented with a pay with credit card option 217C which when selected allows the user to enter their credit card information in the ordinary and standard manner as is known in the art. Once this information is entered and submitted payment is debited from the user's financial account 68 and distributed in the manner described herein and the ordered contact lenses 80 are shipped to the patient 44.

In this way, as one example, the contact ordering process is completed through the application 48.

Contact Clock:

The application 48 is also used to remind the user when to replace their contacts. As an example, many contacts are designed for 1-week wear, 2-week wear, 30-day wear or otherwise. To help remember to replace these contacts at the right time interval, the user selects the contacts clock button 156 on the dashboard screen 152.

Upon selecting the contact clock button 156 the user is presented with the contacts clock screen 218. The contacts clock screen 218 includes an on/off button 220 that turns on and turns off the contacts clock. The contacts clock screen 218 also presents the number of days remaining 222 before the user's contacts should be replaced and the date of change. The number of days between contact changes is either set automatically by the application 48 based upon the manufacturer specifications for the contacts ordered through the application 48, or alternatively it is manually entered by the user. When the number of days remaining goes to zero, the contacts clock sends a message to the user's device which is displayed on its display reminding the user to replace their contacts. The contacts clock screen 218 also includes a snooze button 224 that allows the user to delay the replacement of their contacts and causes the replacement reminder to reappear in a predetermined number of days or user-entered number of days. The contacts clock screen 218 also displays the date of change 226, which can either be the last date of change or the next date of change. The contacts clock screen 218 also includes a reset the clock button 228, which when pressed resets the contacts clock.

The contacts clock helps the user to replace their contacts at the proper intervals thereby helping them to get the best performance out of their contacts.

More Button:

The application 48 includes additional functionality that is presented to the user upon selecting the more button 162. Upon selecting the more button 162 the user is presented with the more screen 230 and is presented with a number of options.

One option is the contact us option 232. Upon selecting the contact us option 232 the user is presented with a plurality of ways to communicate with either their eye care provider 40 or to the application owner or developer. This includes providing their address, phone number, email address or any other contact information. Alternatively, this can include putting the user in direct voice, email, text, instant messaging, video conferencing or other direct and immediate communication through application 48 and the user's device 54. In this way, the contact us option 232 and the ability to quickly and easily communicate improves customer satisfaction, communication between care provider and patient, and strengthens the relationship between the care provider 40 and the patient 44.

Another option is the return policy option 234. In the event the user needs to return contacts they ordered through the application 48 the user selects the return policy option 234 which presents information, policies and procedures as to how to quickly and easily return contact lenses. The return policy option 234 also allows the user to begin the return process. The speed and ease of using this process, and the automation this option provides, reduces the need for additional labor to facilitate these returns.

Another option is the shipping policy option 236. When selected, the shipping policy option provides information regarding the shipping policy.

Another option is the privacy policy option 238. When selected, the privacy policy option 238 provides information regarding the privacy policy.

Another option is the my-prescription-option 240. When selected, the my-prescription-option 240 provides information regarding the user's current as well as past prescriptions.

Another option is the frequently asked questions option 242. When selected the FAQs option 242 provides a plurality of frequently asked questions and answers to those questions.

Another option is the rebate center option 244. When selected, the user is presented with the rebate center screen 246. On the rebate center screen 246 the user is presented with a plurality of applicable rebates 248 from various manufacturers. These rebates 248 include interactive links that allow the user to learn more about each rebate and even submit their rebate directly through the application 48 allowing for easier submission and therefore a better user experience.

Another option is the order history option 250. When selected, the order history option 250 provides the user's order history, as well as any other orders linked to the user's account. This is further described with respect to the ability for a single user to order contact lenses for a plurality of patients 44, such as the mom or dad ordering contact lenses for themselves as well as their children. The order history option 250 also presents receipts that may be needed to secure rebates 248.

Application Screens—Care Provider Side of the Application:

Many similarities exist between the care provider's side of the application 56 and the patient's side of the application 58 and therefore reference is made to the above description of the patient side of the application so as to eliminate redundant descriptions.

As one example, upon opening the application 48 on an internet enabled device 46, such as a mobile device, the care provider is presented with a home screen 100 and the care provider selects the proper option of either pressing the login button 102 or the register as a new user button 104. Next, the care provider selects the register as a doctor button 112 or login as a doctor button.

In the event the care provider 40 is a registered user of the application 48, on the care provider login screen 300 the care provider logs in by entering their e-mail ID into the enter your email ID box 302 and password into the enter your password box 304 and then pressing the login button 306.

Alternatively, if the care provider 40 is not yet a registered user of the application, the care provider 40 goes through a similar process of registering as that described herein with respect to the patient/user (and therefore detailed reiteration of this process is unnecessary). However, the care provider must enter their prescribing authority, such as their medical license information as well as their practice name, office location and other relevant information regarding their practice. This information is either automatically verified by application 48 through the internet, or alternatively this information is transmitted to the application owner or manager which then manually verifies that the care provider 40 is authorized to write prescriptions. The care provider can also select the remember-my-password button 308 as is described herein.

Once logged in to the application 48, the care provider 40 is presented with the care provider dashboard screen 310. On the care provider dashboard screen 310 the care provider 40 is presented with the new patient button 312, existing patient button 314, contact calculator button 316, ledger button 318, more button 320 and promotions button 322.

New Patient:

Upon selecting the new patient button 312, the care provider 40 is presented with the new patient screen 324 where the care provider 40 is presented with a first name box 326 wherein the care provider 40 enters the first name of the patient 44, a last name box 328 wherein the care provider 40 enters the patients last name, and a scan the code button 330 or manually enter the code button 332. When the scan the code button 330 is pressed, the care provider's mobile device 46 automatically opens a scanning function and the mobile device 46 is used to scan or capture the passcode 42 contained on the card or document 78 provided to the patient 44 by the eye care provider 40. The scanning function automatically decodes the encrypted code and transmits it through the electronic network, internet or cloud 50 to the application 48 where it is stored for matching or correlation when the patient 44 enters or scans the same passcode 44 in the manner described herein.

Next, the care provider 40 is presented with the parameters screen 334 wherein the care provider enters the prescription parameters 41A into the application 48. As an example, the care provider is presented with an eye selection button 336 which allows the care provider 40 to select the eye for which the prescription 41 is being entered; a manufacturer selection box 338 which allows the care provider to enter or select from a pre-populated list the desired manufacturer for the prescribed contact lenses; a lens type box 340 which allows the care provider 40 to enter or select from a pre-populated list the desired lens type for the prescribed contact lenses; a base curve box 342 which allows the care provider to enter or select from a pre-populated list the desired base curve for the prescribed contact lenses; a sphere power box 344 which allows the care provider to enter or select from a pre-populated list the desired sphere power for the prescribed contact lenses; a cylinder power box 346 which allows the care provider to enter or select from a pre-populated list the desired cylinder power for the prescribed contact lenses; a cylinder axis box 348 which allows the care provider to enter or select from a pre-populated list the desired cylinder axis for the prescribed contact lenses. Once these fields have been entered for both eyes, the care provider selects the done button 350 and the prescription 41 and prescription parameters 41A are saved in database 50 within application 48 and is associated with passcode 42 for later use when patient 44 accesses the application 48 using passcode 48.

Existing Patient:

Alternatively, in the event the care provider 40 has a patient 44 that previously used application 48 or was previously entered into application 48, the care provider selects the existing patient button 314. Once the existing patient button 314 is selected the care provider 40 is presented with the existing patient screen 352. Once on the existing patient screen 352 the care provider 40 is presented with an enter the existing code box 354, wherein the care provider 40 enters or scans in a previous passcode 42 associated with the patient 44. Also presented on the existing patient screen 352, the care provider is presented with an enter patient's name box 356, wherein the care provider enters an existing patient's name. Once either field is entered, search results 358 are presented on the screen from which the care provider 40 can select. As one example, the care provider enters the last name of the patient into the box 356 which pulls up all the patients that match or correlate to that entered name, and the care provider 40 selects the appropriate patient from the list. Once the existing patient 44 is selected, the care provider 40 can then enter the prescription 41 and prescription parameters 41A in the manners described herein.

Contact Calculator:

Upon selecting the contact calculator button 316, the care provider 40 is presented with the contact calculator screen 360 which is used by a care provider 40 to determine the best contact lenses to prescribe. The contact calculator screen 36 presents a vertex distance/crossed cylinders toggle button 362 which toggles the functionality of the contact calculator between vertex distance and crossed cylinders.

On one selection of the vertex distance/crossed cylinders toggle button 362, the contact calculator includes a desired sphere power box 364, a desired cylinder power box 366, a refracted vertex distance box 368 and a calculate button 370. When these entry fields 364, 366, 368 are filled in and the calculate button 370 is pressed, suggested prescriptions to order are presented in the prescription to order field 372.

Similarly, on the other selection of the vertex distance/crossed cylinders toggle button 362, the contact calculator includes a first sphere power box 374, a first cylinder power box 376, a first cylinder axis box 378, a second sphere power box 380, a second cylinder power box 328 and a second cylinder axis box 384 and the same calculate button 370. When these entry fields 374, 376, 378, 380, 382, 384 are filled in and the calculate button 370 is pressed, suggested prescriptions to order are presented in the prescription to order field 372.

This contact calculator provides the care provider with a quick, convenient and easy to use tool that helps to accurate calculate the best contacts to prescribe.

Ledger:

Upon selecting ledger button 318 on the care provider dashboard screen 310 the care provider 40 is presented with the ledger screen 386. The ledger screen 386 includes a ledger or list of all the patients' names 388, lens types 390 and revenue 392 prescribed and/or ordered through application 48. These categories are merely examples, and any other number of categories of information can be included in this list such as date, month, manufacturer, etc. This ledger allows the care provider 40 to quickly and easily keep track of their utilization of the application 48.

Care Provider More Button:

Upon selecting the more button 320, the care provider 40 is presented with a plurality of additional functions of the application 48. Upon selecting the more button 320, the care provider 40 is presented with the care provider more screen 394, which has similar functionality to that of the user more screen 162 described herein.

More specifically, the care provider more screen 394 includes a contact us option 396, a refer a doctor option 398, a lens list and pricing option 400, a frequently asked questions option 402, a terminate the account option 404, a communicate with the patients option 406, a rebate center option 408, an edit contact details option 410, an order contacts option 412 and a how to use mobilelensdoc option 414.

Upon selecting the contact-us-option 396, the care provider 40 is presented with a plurality of ways to communicate with the application owner or developer. This includes providing their address, phone number, email address or any other contact information. Alternatively, this can include putting the care provider in direct voice, email, text, instant messaging, video conferencing or other direct and immediate communication through application 48 and the care provider's device 46. In this way, the contact us option 396 and the ability to quickly and easily communicate improves care provider satisfaction with the application, communication between care provider and application owner or developer, and strengthens the relationship between the care provider 40 and the application owner or developer.

Upon selecting the refer a doctor option 398, the care provider 40 is presented with a plurality of ways to communicate with other care providers to suggest that they use the application 48 or nominate them for use. This includes providing their address, phone number, email address or any other contact information to the application owner or developer, sending an email or text invitation, or any other manner or method of referring them to the application 48.

Upon selecting the lens list and pricing option 400, the care provider 40 is presented with a list of lenses that can be ordered through the application 48 as well as their pricing.

Upon selecting the frequently asked questions option 402, the care provider 40 is presented with a plurality of frequently asked questions and answers to those questions.

Upon selecting the terminate the account option 404, the care provider 40 is presented with a screen that provides information about how to terminate their account with the application 48 and enables them to quickly and easily terminate their account.

Upon selecting the communicate with the patients option 406, the care provider 40 is presented with a plurality of options as to how to communicate through the application 48 with their patients 44 that utilize the application 48. This includes sending e-mails, texts, instant messages, reminders or any other communication through the application that are displayed on the patients' devices 54 in or outside of the application 48.

Upon selecting the rebate center option 408, the care provider 40 is presented with a screen that provides information about rebates from various manufacturers. These rebates include interactive links that allow the user to learn more about each rebate and even allow the care provider to submit a rebate directly through the application 48 allowing for easier submission and therefore a better user experience.

Upon selecting the edit contact details option 410, the care provider 40 is presented with a screen that allows the care provider 40 to edit their contact details.

Upon selecting the edit order contacts option 412, the care provider 40 is presented with a screen that allows the care provider 40 to order contacts for personal use or as samples.

Upon selecting the how to use mobile lens doc option 414, the care provider 40 is presented with a screen that provides the care provider 40 with additional information as to how to use the application 48 including tutorials.

Development of Cards and Documents:

When a care provider 40 registers with the application 48 the application assigns a plurality of unique passcodes 42 to the care provider 42. These passcodes 42 are unique in that they are one-time-use only, meaning that a single passcode 42 is only assigned to a single care provider 40 and the care provider 40 only assigns a single passcode 42 to a single patient 44, so as to prevent any confusion. The passcodes 42 can be embodied in a manual code such as standard text letters, numbers and/or characters. In another arrangement, the passcode is contained within a scannable code such as a bar code, QR code, a 2D-code, an optical code, a near-field communication (NFC) code or any other electronically perceivable code. In one arrangement the passcode is encrypted.

In one arrangement, when a care provider 40, such as an eye doctor, enrolls in application 48 the application owner or developer ships the care provider a plurality of cards or documents or stickers 78 having unique passcodes 42 thereon. Then each time the care provider 40 examines a patient 44 the care provider selects a new card 78, scans or enters the passcode 42 from that card 78 and enters or associates the patient's prescription 41 and/or prescription parameters 41A with that passcode 42 in the manners described herein. Once entered, the care provider 40 hands the card 78 to the patient 44 who later enters or scans the passcode 42 into the application 48 in the manners described herein to order their contacts through the application 48.

In another arrangement, the application 48 provides the care provider the ability to quickly and easily print their assigned passcodes 42 themselves onto business-type cards, directly onto the document that traditionally eye prescriptions are entered onto, or any other document.

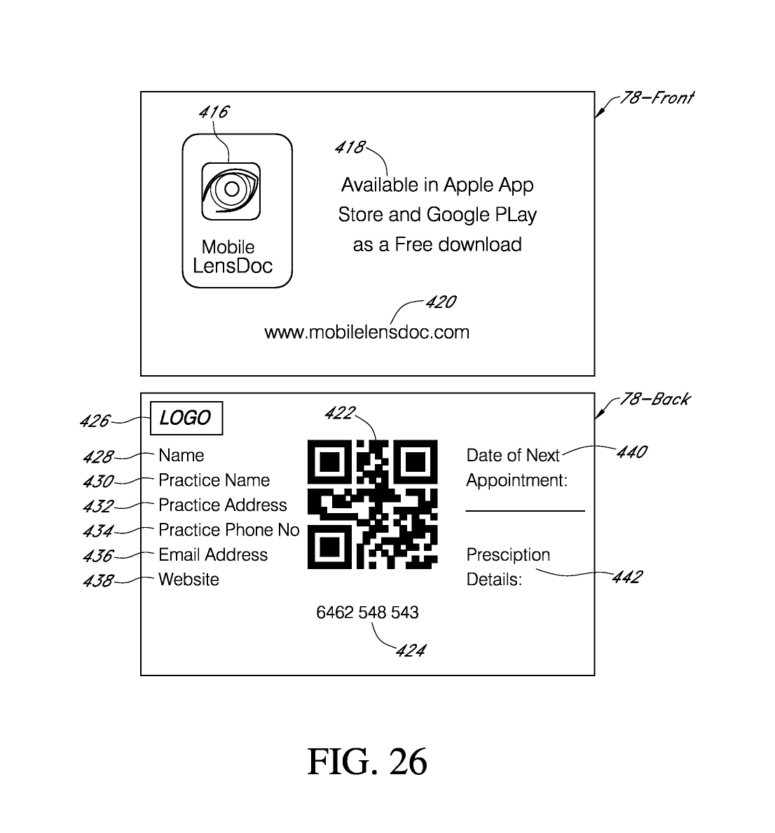

In one arrangement, application 48 includes a design your own card module which allows the care provider to take a card template, such as that presented in FIG. 26, which includes standard information related to the application 48 and add personalized information thereto.

More specifically, the card 78 template, includes standard features such as for example: application logo 416, brief instructions 418 on how to download the application 48, application web address 420, a scannable code 422 that embodies the passcode 42, and a manual or text code 424 that embodies the passcode 42.

The card 78 template also includes customizable features that enable a care provider to provide information about the patient's own care provider 40 such as for example: the care providers logo 426, the doctors name or eye care provider's name 428, the practice name 430, the practice address 432, the practice phone number or eye care provider's phone number 434, the doctor or eye care provider's email address 436, the eye care provider's website 438, the blank for or date or the next appointment 440 and prescription details 442 as well as any other type of information.

Adding these additional areas of information provide a personalized touch and provide greater value to the care provider 40 and the patient 44 by placing more information in a single convenient place, that is on the card 78 itself.

Not only can the cards 78 be customized, however the appearance of the application 48 can be customized for each eye care provider 40. That is, when the patient scans in or enters their unique passcode, the application 48 associates the passcode 42 with the particular prescribing eye care provider 40 and presents the specific background and appearance of the application 48 to the patient. This “multi-tenant format” that allows eye care providers 40 to customize the look, feel, pricing, etc. within this mobile application 48.

Entering Multiple Codes:

The system 10 can also be used by a single user to order multiple prescriptions 41 for multiple patients 44, such as for example a parent ordering contact lenses for a child. This occurs by a user logging into the application 48 and scanning a second code and ordering the contact lenses in the manners described herein.

Summary of Active Verification and Security Measures:

In summary, the system 10 presented herein provides a number of safeguards never before offered to ensure that the patient's prescription 41 is protected while also allowing the patient 44 to have quick and easy access to ordering the prescription 44.

The first layer of protection is that the passcodes 42 that are utilized by the application 48 are password protected in application 48 or database 60 associated with the application 48. That is, passcodes 42 can only be assigned to an eye care provider 40 by the application 48 or an administrator of the application 48 that passes through a secured gateway, such as entering verified username and passwords. In addition, cards 78 containing passcodes 42 can only be printed by the application 48 itself or an administrator of the application 48 that passes through a secured gateway, such as entering verified username and passwords; or alternatively by an eye care provider 40 that has been granted the right and ability to print cards through an administrator-type account after passing through a secured gateway, such as entering verified username and passwords. Therefore cards 78 containing passcodes 42 can only be printed by authorized parties.

The second layer of protection is that the passcodes 42 are assigned to a specific eye care provider 40, such as a specific eye doctor. Therefore, to access the passcode 42 in the application 48 the appropriate eye care provider 40 or eye doctor must be logged into the application 48 when they enter or scan the passcode 42 to associate the passcode with the patient 44 and/or prescription 41. If the wrong cards 78 end up in the doctor's hands, when they go to scan in or enter the passcode 42 the application 48 will reject the passcode 42 because it has not been assigned to that doctor. As such, only the proper passcodes 42 can be entered by any one eye care provider 40.

The third layer of protection is that the patient 44 must download the application 48 and enter the passcode 42 into the application. Unless the appropriate passcode 42 is used in the appropriate application 48 the passcode 42 is useless and ineffectual.

The fourth layer of protection is that the patient 44 and the eye care provider 40 are provided with a plurality of review screens wherein they are provided with the opportunity to double-check the accuracy of the prescription 41.

The fifth layer of protection is that the passcodes 42 are one-time-use codes that expire permanently upon entry into the system 10. Once the passcode 42 is scanned in, the user has the opportunity to enter a username and password. Once the user account is established it is protected by the username and password and scanning in the passcode 42 has no affect and will not provide access into the application 48 again.

The sixth layer of protection is that the prescription 41 associated with the passcode 42 expires after a predetermined amount of time, such as 1-year from the date of writing the prescription 41.

Therefore, the system 10 and application 48 provide a great degree of protection.

Existing Users:

When existing users return to their eye care provider 40 there is no need to issue them another card 78 because both the eye care provider 40 and the patient 44 are affiliated with the application 48. All the eye care provider 40 must do is open the application 48, find the patient 44 and enter the new prescription 41 which will then be active for the predetermined amount of time (such as one year). Similarly, to order contacts, the established patient 44 only needs to open the application 48 and enter their username and password and they will be presented with their new prescription 41.

In addition, if the eye care provider 40 or patient 44 changes their electronic device, all they need to do is download the application 48 to their new device, or access the application 48 through the internet or cloud, and enter their username and password and they will be provided access to the application 48. All necessary information is stored in database 60 and/or the cloud 50 and therefore it is not dependent on any one device.

In Operation:

As one example of using the system 10, a doctor or care provider 40 that desires to use the system 10 downloads that application 48 to their handheld device 46. Next, while on the home screen 100 the care provider 40 selects the start as a new user button 104 and then on the new user screen 106 selects the register as a doctor button 112. Next the care provider 40 enters their first name, last name, email ID, password and confirms their password. Next, the care provider 40 enters their practice name, practice location address, practice location city, practice location zip code, practice state, state license number (or other prescribing authority) contact number and any other necessary or helpful information. Once this information has been entered, the care provider presses a request membership button.

Once the request membership button is pressed, the application 48 either manually or automatically begins the verification process. In a manual verification process, this information is transmitted to an administrator who manually verifies the care provider's credentials and entered information. In an automatic verification process, the application 48 cross-references the entered information with a database of doctors and care providers 40 supported by a third party such as a state medical board, a federal health organization, a medical licensing administration organization or the like. Once the prescribing authority of the doctor or care provider 40 has been objectively verified, and the credentials, reputation, character, etc. of the doctor or care provider 40 has been subjectively verified by the administrator of the application 48 the doctor or care provider 40 becomes a registered or verified user of the application 48 and the eye care provider account 62 is established in the eye care provider side 56 of application 48.

Upon becoming a user of the application 48, the doctor or care provider 40 is assigned a plurality of passcodes 42. These passcodes 42 are unique and one time use only, meaning that no other doctor or eye care provider 40 is assigned the same passcode 42 and when the passcode 42 is used it is permanently terminated for use in the system 10. That is, when the passcode 42 is (1) assigned to a care provider 40, (2) has a prescription 41 associated with the passcode 42 by a care provider 40, and (3) the passcode 42 is entered by a patient 44 into the application 48, or more than the predetermined amount of time passes (such as 1-year) from the time of entering the prescription 41, the passcode 42 becomes completely inoperative.

Once the passcodes 42 are assigned to the care provider 40, the care provider 40 can order cards 78 (such as those shown in FIG. 26) directly through the application 48 which are then shipped to the doctor or care provider 40 by the application 48. Alternatively, the doctor or care provider 40 can download the passcodes 42 themselves and generate their own cards or documents 78 having the passcodes 42 printed thereon. These documents or cards 78 can include information personalized to the care provider 40, such as their name, logo, address, phone number and the like. In one arrangement, these passcodes, both in plain text as well as in scannable code form, can be printed directly onto the document that the patient's prescription 41 is printed on. In one arrangement, application 48 includes a portal that allows the care provider 40 to design custom cards 78 having the unique passcodes 42 thereon.

Next, the care provider 40 examines the patient 44 and prescribes a prescription 41 for contact lenses. Next, the care provider 40 takes out their device 46, opens application 48, selects the login button 102 on the home screen 100 and enters their email into box 302 and password into box 304 and presses the login button 306 of the login screen 300; or alternatively the care provider 40.

Next, if the patient 44 is a new patient, the doctor selects the new patient button 312 on the care provider dashboard screen 310. Next, the care provider 40 enters the patient's first name into box 326 and last name into box 328 on the new patient screen 324. Next, the care provider 40 selects a document or card 78 having a passcode 42 thereon and either scans the code by pressing the scan the code button 330 or enters the passcode 42 by typing into the manually enter the code box 332. Once the passcode 42 is inputted into the application 48 the care provider 40 verifies which takes the care provider to the enter parameters screen 334.

One on the enter parameters screen 334 the care provider 40 selects the eye using eye selection button 336 and then enters each of the needed parameters in boxes 340-348 by entering this information or selecting it from drop down menus populated by information stored in the application and/or the database 60 associated therewith. Once the needed information has been entered and verified by care provider 40, the done button 350 is pressed and the prescription 41 and prescription parameters 41A are associated with the particular passcode 42 in application 48 and/or saved in database 60.

Now that the prescription 41 and prescription parameters 41A have been entered into the application 48, associated with the passcode 42 and patient 44 and stored in the application/database 60, the document or card 78 is provided to the patient 44.

If the patient 44 desires to use the application 48 to order their contact lenses for the first time (that is they are a new user), the patient 44 reads the instructions on the card 78, opens their mobile device or hand held device 54 and downloads the application 48. Once the application 48 is opened, while on the home screen 100 the patient 44 selects the start as a new user button 104 and then on the new user screen 106 they select the scan the code button 108 or selects the manually enter the code button 110 and they scan the scannable passcode 42 on the card or document 78 or enter the plain text passcode 42 on the card or document 78, respectively. Once scanned or entered, the patient 44 verifies the passcode 42 is correct on verification screen 114 and if it is correct they press the continue to next step button 116.

Once the continue to next step button 116 is pressed application 48 correlates the passcode 42 scanned or entered by the patient 44 with the passcodes 42 assigned to care providers 40 and stored in the system 10, application 48 and/or database 60. If there is a match or correlation and the passcode 42 has not expired due to the passage of more than the predetermined amount of time or already been entered, the application 48 proceeds to the next steps. In one manner of speaking, this process is the active verification step.

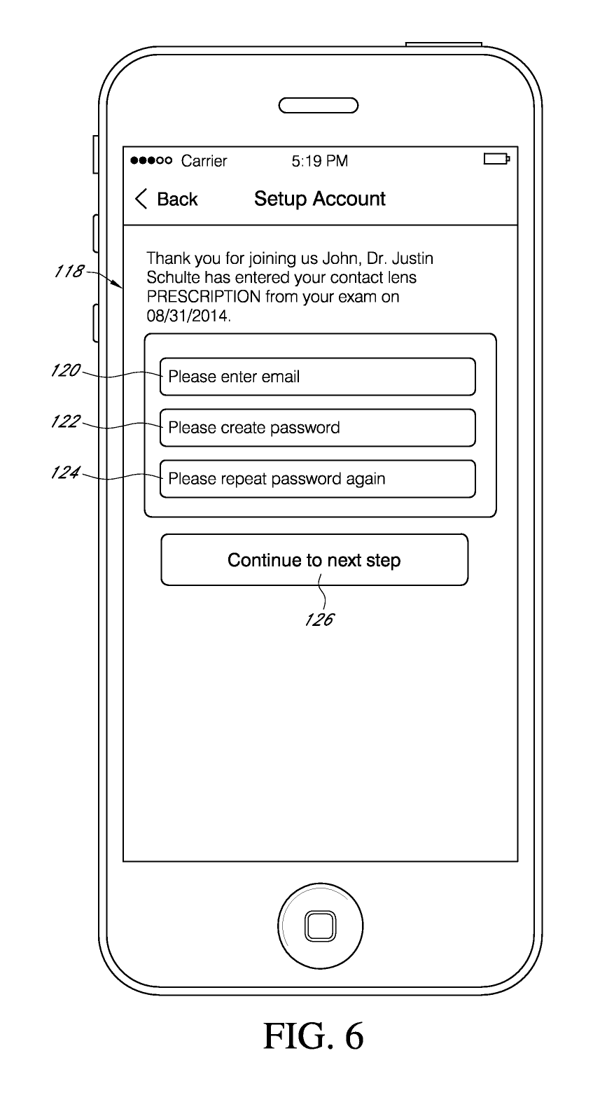

Once the active verification step occurs, the patient 44 is allowed to proceed to the next steps in the process. That is, the patient is allowed to pass to the setup account screen 118 where the new user enters their email into box 120, password into box 122 and confirms password into box 124 before pressing the continue to the next step button 126. Also, on this screen 118, as is shown in FIG. 6, the application 48 displays a welcome from the patient's care provider 40 that includes the care provider's name and date of exam.

Next, the new user enters their shipping address into boxes 130-136 on screen 128 prior to pressing the complete your profile button 138, which completes the patient's profile and forms the patient account 64 in the application 48.

Next, the user is presented with the user dashboard screen 152. To order contacts, the user selects the order contacts button 154 which takes them to the order contacts screen 166. On this screen, the user compares the displayed prescription 41 and prescription parameters 41A with those handed to the patient 44 at the exam. If the displayed prescription 41 and prescription parameters 41A match what was provided, the user presses the select a supply to order button 180 and then on screen 186 selects the quantity option 188 and shipping option 190 and presses the done button 192. Next, they verify the total 206, shipping address 21 and if correct and acceptable they press the proceed to payment button 216.

On the payment screen 217, the user selects the payment option 217A and pay for their contact lenses. Once payment is selected the funds are debited from the patient's financial account 68, transmitted to in whole or in part to, or distributed amongst the supplier's financial account 76, the application's financial account 82 and the care provider's financial account 66.

Once payment is made to the supplier 70, the supplier 70 ships the contact lenses to the patient 44.

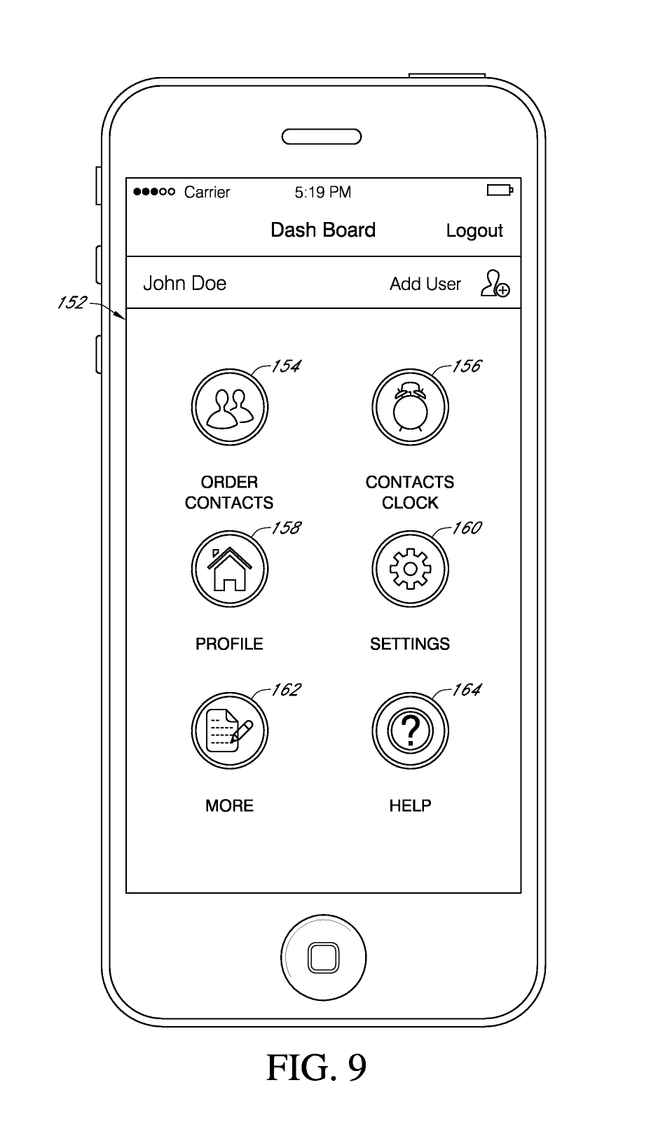

In the event that the same user wants to order contacts for someone else, such as their wife, husband or child, on the user dashboard screen 152, the user presses the logout button displayed in the upper right hand corner (FIG. 9) and the user is taken back to the home screen 100, wherein the user repeats the same process described here. This allows the same user to order contact lenses for a plurality of people.

In the event that the same patient 44 returns to the same eye care provider 40 there is no need to assign them a new passcode 42 as the patient's name and information is stored in the application 48. As such, the care provider 40 selects the existing patient button 314 on the care provider dashboard screen 310, and enters the existing code in box 354 or enters the patient's name in box 356 and selects the correct patient name from the results list 358. Once the correct existing patient is selected, the care provider is presented with the add lens parameters screen 334 and the care provider enters the prescription 41 and prescription parameters 41A in boxes 336-348 and presses the done button.

Thereafter, the patient 44, which is already an existing user of application 48, merely opens the application 48, selects the login button 102 on the home screen 100 and then logs into the application using their existing user name and password. They will then be presented with the user dashboard screen 152 and they can order the new prescription of contacts 41 by selecting the order contacts button 154. Once the order contacts button 154 is pressed the user is presented with both their prior prescription 41 (which has likely expired) as well as their new prescription 41 (which has likely not expired and therefore they can order contacts based on the new prescription 41).

In this way the system 10 presented provide an extremely convenient, simple and easy system to use for both the patient 44 and the care provider 40.

Terms:

All terms contained herein are meant to have their broadest possible interpretation, and therefore unless specifically identified, the terms are not meant to be limiting.

That is, the terms doctor, eye care provider and care provider are not meant to be limiting. That is, a doctor may be an eye care provider and a care provider as well. Similarly, a care provider may include one or more doctors and one or more eye care providers. Similarly, an eye care provider may include one or more doctors and/or one or more care providers. Accordingly the terms are not meant to be limiting. In addition, while the application is described herein as being used in association with contact lenses, however the system again is not so limited and is contemplated for use outside of the contact lens industry and any reference to the contact lens industry is example purposes.

Similarly, the terms user and patient are not meant to be limiting. A user is anyone that is a user of the application 48 and can be any one of a doctor, patient, a non-patient, a care provider, an eye care provider, or anyone else. A user can be a patient, and a patient can be a user, and so on and therefore the terms are not meant to be limiting.

Similarly, the terms code, scannable code, passcode are not meant to be limiting and instead are any form of a code.

The terms device, handheld device, computer, electronic device, wireless device, internet enabled device or the like are not meant to be limiting and include any electronic device that performs the functions described herein.

From the above-discussion, it will be appreciated that the system, method and application for ordering contact lenses shown, described and presented herein improves upon the state of the art and achieves some or all of the stated objectives.

Specifically, the system, method and application for ordering contact lenses shown, described and presented herein: provides for quick, easy and efficient active verification of a contact lens prescription; is easy for the patient to use; is easy for the eye care provider to use; reduces the cost to patients when ordering contact lenses; reduces the cost to eye care providers when ordering contact lenses; is efficient; eliminates the need to manually verify a contact lens prescription by an eye care provider; is simple; is straight forward eliminates the need to manually enter prescription parameters or prescription information; allows the patient to scan in a code that automatically connects them to their prescription information; provides an incentive for patients to use, namely ease of use, efficiency of use, simplicity and low; provides an incentive for eye care providers to use, namely ease of use, efficiency of use, simplicity and low prices and eliminating the need for manual verification; improves the accuracy of ordering contact lenses; provides a financial benefit to the eye care provider for using the system; provides improve patient compliance with contact lens replacement schedules by providing reminders on mobile devices; provides an annual examination recall reminder (such as at 11 months from their last contact lens prescription date) specific to a provider via local push notification on a mobile device; provides the capability to communicate with their patients via local push notification on their mobile devices; improves office efficiency by eliminating contact lens prescription verification or ordering, and eliminating shipping costs, packaging, and phone calls regarding fulfillment of contact lens orders; provides a doctor contact lens calculator such as for vertex distance and crossed cylinder; provides for manufacturer promotions; provides the convenience of multiple users and addresses associated with a single account as may be appropriate for use by a family, among countless other objects, features and advantages.

It will be appreciated by those skilled in the art that other various modifications could be made to the device without parting from the spirit and scope of this invention. All such modifications and changes fall within the scope of the claims and are intended to be covered thereby.

What is claimed:

1. Method of supplying a prescription using a web-based application, the steps comprising:
providing a web-based application associated with a database;
accessing the application by a care provider;
establishing a care provider account in the application by the care provider;
assigning a code to the care provider;
examining a patient by the care provider;
prescribing a prescription by the care provider to the patient;
associating the prescription with the code assigned to the care provider in the application;
accessing the application by the patient;
establishing a patient account in the application by the patient;
entering the code by the patient;
verifying the code entered by the patient with the code associated with the prescription;
ordering the prescription by the patient through the application; and
shipping the prescription to the patient by a supplier.

2. The method of claim 1, wherein the care provider establishes the care provider account by entering a care provider username, address and prescribing authority which are saved in the database.

3. The method of claim 2 further comprising the step of verifying the care provider's prescribing authority of through a third party.

4. The method of claim 1 wherein the patient establishes the patient account by entering the patient's username and address.

5. The method of claim 1 further comprising the step of associating a care provider's financial account with the care provider account.

6. The method of claim 1 wherein the code is encrypted.

7. The method of claim 1 wherein the code is unique.

8. The method of claim 1 wherein entering the code by the patient is performed by manually entering the passcode or scanning a code.

9. The method of claim 1 further comprising the step of:
associating a care provider's financial account with the care provider's account; and
transferring a portion of a purchase price for the prescription to the care provider's financial account when the prescription is ordered by the patient.

10. The method of claim 1 further comprising the step of:
associating a patient's financial account with the patient account; and
transferring at least a portion of a purchase price for the prescription to a supplier's financial account when the prescription is ordered by the patient.

11. The method of claim 1 further comprising the step of:
establishing a supplier account in the application;
associating a supplier's financial account with the supplier account; and
transferring at least a portion of a purchase price for the prescription to the supplier's financial account.

12. The method of claim 1 wherein the prescription is a contact lens prescription.

13. The method of claim 1 wherein verifying the code entered by the patient with the code associated with the prescription occurs when the code entered by the patient matches or corresponds with the code associated with the prescription.

14. The method of claim 1 wherein verifying the code entered by the patient with the code associated with the prescription occurs when the code entered by the patient matches or corresponds with the code associated with the prescription and a patient name associated with the prescription matches or corresponds with a patent name associated with the patient account.

15. A method of ordering a prescription, the steps comprising:
providing a web-based application associated with a database;
accessing the application by a care provider over an electronic network through a first electronic device having a display;
establishing a care provider's account in the application by the care provider;
examining a patient by the care provider;
providing a prescription for the patient by the care provider;
associating the prescription with a code assigned to the care provider;
providing a document having a code thereon;
associating the code with the prescription in the application;
providing the document to the patient;
accessing the application by patient over an electronic network through a second electronic device having a display;
establishing a patient account in the application by the patient;
entering the code from the document into the application by the patient;
verifying the code entered by the patient matches or corresponds with the code associated with the prescription by the application;
displaying the prescription to the patient through the application on the second electronic device; and
ordering the prescription through the application by the patient.

16. The method of claim 15 further comprising the step of associating a doctor's financial account with the doctor account.

17. The method of claim 15 wherein the code on the document is embodied within a scannable code, bar code, QR code, a Near-Field Communication (NFC) code, an electronic code, or an optical code.

18. A method comprising the steps of:
providing an application for use on an internet enabled device;
associating the application with a database;
providing a first portion in the application for use by an eye care provider, the first portion having a user interface for specifying contact lens parameters;
accessing the first portion by an eye care provider through a first internet enabled device;
specifying contact lens parameters by the eye care provider into the first portion;
associating the contact lens parameters with a code;
storing the contact lens parameters in the database;
providing the code to the patient;
providing a second portion in the application for use by the patient, the second portion having a user interface for inputting the code and ordering contact lenses;
accessing the second portion by the patient through a second internet enabled device;
inputting the code by the patient into the second portion;
retrieving the contact lens parameters entered by the eye care provider from the code;
displaying the contact lens parameters to the patient; and
ordering contact lenses through the application by the patient.

19. The method of claim 18 further comprising the step of providing a portion of a purchase price for the contact lenses to the eye care provider.

20. The method of claim 18 wherein the code is selected from the group consisting of a digital code, a QR code, a manual code (characters, numbers, letters), a skew code, a bar code, a password, a Near-Field Communication (NFC) code, an electronic code or an optical code.

21. A method of providing active contact lens verification, comprising the steps of:
accessing a cloud-based service by an eye care provider;
entering by the eye care provider contact lens parameters for a patient into the cloud-based service;
storing the contact lens parameters for a patient in a database associated with the cloud-based service;
associating a code with the patient;
providing the code to the patient by the eye care provider;
accessing the cloud-based service by the patient;
receiving the code from the patient through the cloud-based service;
displaying the contact lens parameters to the patient in response to receiving the code; and
receiving an order for contact lenses from the patient.
